(19) United States
(12) Patent Application Publication
(10) Pub. No.: US 2025/0105901 A1
(43) Pub. Date: Mar. 27, 2025

(54) METHOD AND USER EQUIPMENT FOR BEAM INDICATION IN MTRP

(71) Applicant: FG Innovation Company Limited, Tuen Mun (HK)

(72) Inventors: JIA-HONG LIOU, Taipei (TW); CHIA-HUNG LIN, Taipei (TW)

(21) Appl. No.: 18/293,555

(22) PCT Filed: Jul. 25, 2022
(86) PCT No.: PCT/CN2022/107663

§ 371 Date: Jan. 30, 2024

Related U.S. Application Data
(60) Provisional application No. 63/203,812, filed on Jul. 30, 2021.
(60) Provisional application No. 63/227,868, filed on Jul. 30, 2021.

(51) Int. Cl. H04B 7/06; H04W 72/20

(52) U.S. Cl. CPC H04B 7/0695; H04W 72/20

(57) ABSTRACT

A user equipment (UE) and a method for beam indication in a multi-transmission and reception point (MTRP) are provided. The method includes: receiving, from a base station (BS), first downlink control information (DCI) including a first transmission configuration indication (TCI) field indicating a first TCI state, the first DCI being associated with a first value; receiving, from the BS, second DCI including a second TCI field indicating a second TCI state, the second DCI being associated with a second value; performing, based on the first TCI state, a first uplink (UL) transmission; and performing, based on the second TCI state, a second UL transmission. The first UL transmission is scheduled by third DCI associated with the first value, and the second UL transmission is scheduled by fourth DCI associated with the second value.

### CROSS-REFERENCE TO RELATED APPLICATION(S)

The present disclosure claims the benefit of and priority to U.S. Provisional Patent Application Ser. No. 63/227,868, filed on Jul. 30, 2021, entitled “METHOD AND APPARATUS FOR INDICATING TRANSMISSION CONFIGURATION INDICATOR AND TRANSMISSION SCHEME IN A WIRELESS COMMUNICATION SYSTEM” (“the '868 provisional”) and U.S. Provisional Patent Application Ser. No. 63/203,812, filed on Jul. 30, 2021, entitled “METHOD AND APPARATUS FOR INDICATING TRANSMISSION CONFIGURATION INDICATOR AND TRANSMISSION SCHEME UNDER MULTIPLE-TRP SCENARIO IN A WIRELESS COMMUNICATION SYSTEM” (“the '812 provisional”). The contents of the '868 provisional and the '812 provisional are hereby incorporated fully by reference into the present disclosure for all purposes.

### FIELD

The present disclosure is related to wireless communication and, more particularly, to a method and a user equipment (UE) for beam indication in Multi-Transmission and Reception Point (MTRP) in next generation wireless communication networks.

### BACKGROUND

Various efforts have been made to improve different aspects of wireless communication for cellular wireless communication systems, such as 5G New Radio (NR), by improving data rate, latency, reliability, and mobility. The 5G NR system is designed to provide flexibility and configurability to optimize network services and types, accommodating various use cases such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a method and a user equipment for beam indication in Multi-Transmission and Reception Point (MTRP) in next generation wireless communication networks.

In a first aspect of the present disclosure, a method performed by a user equipment (UE) for beam indication in Multi-Transmission and Reception Point (MTRP) is provided. The method includes: receiving, from a Base Station (BS), a Radio Resource Control (RRC) configuration including a RRC parameter indicating a Transmission Configuration Indication (TCI) state type in a serving cell; receiving, from the BS, a Medium Access Control (MAC) Control Element (CE) including at least one TCI codepoint mapping to at least two TCI states; receiving, from the BS, Downlink Control Information (DCI) including a TCI field indicating the at least two TCI states mapped in the at least one TCI codepoint, the at least two TCI states being associated with a first Transmission and Reception Point (TRP) and a second TRP; and performing communications with the first TRP and the second TRP based on the at least two TCI states.

In an implementation of the first aspect of the present disclosure, the RRC parameter indicates a joint TCI state type, the at least two TCI states include a first joint TCI state and a second joint TCI state, the first joint TCI state corresponds to the first TRP, the second joint TCI state corresponds to the second TRP, and the method further comprises: performing first DL reception and first UL transmission with the first TRP based on the first joint TCI state; and performing second DL reception and second UL transmission with the second TRP based on the second joint TCI state.

In an implementation of the first aspect of the present disclosure, the RRC configuration further indicates one or more TCI state lists, and the first joint TCI state and the second joint TCI state are obtained from a joint TCI state list of the one or more TCI state lists.

In an implementation of the first aspect of the present disclosure, the RRC parameter indicates a separate TCI state type, the at least two TCI states include a first DL TCI state, a first UL TCI state, a second DL TCI state and a second UL TCI state, the first DL TCI state and the first UL TCI state correspond to the first TRP, the second DL TCI state and the second UL TCI state correspond to the second TRP, and the method further comprises: performing first DL reception with the first TRP based on the first DL TCI state; performing first UL transmission with the first TRP based on the first UL TCI state; performing second DL reception with the second TRP based on the second DL TCI state; and performing second UL transmission with the second TRP based on the second UL TCI state.

In an implementation of the first aspect of the present disclosure, the RRC configuration further indicates one or more TCI state lists, the first DL TCI state and the second DL TCI state are obtained from a DL TCI state list of the one or more TCI state lists, and the first UL TCI state and the second UL TCI state are obtained from a UL TCI state list of the one or more TCI state lists.

In an implementation of the first aspect of the present disclosure, the first TRP is associated with a first TRP identifier (ID), and the second TRP is associated with a second TRP ID.

In an implementation of the first aspect of the present disclosure, the first TRP is associated with a first Control Resource Set (CORESET) pool index, and the second TRP is associated with a second CORESET pool index.

In a second aspect of the present disclosure, a UE for beam indication in MTRP is provided. The UE includes one or more non-transitory computer-readable media having computer-executable instructions embodied thereon; and at least one processor coupled to the one or more non-transitory computer-readable media. The at least one processor is configured to execute the computer-executable instructions to: receive, from a Base Station (BS), a RRC configuration including a RRC parameter indicating a TCI state type in a serving cell, receive, from the BS, a MAC CE including at least one TCI codepoint mapping to at least two TCI states, receive, from the BS, DCI including a TCI field indicating the at least two TCI states mapped in the at least one TCI codepoint, the at least two TCI states being associated with a first TRP and a second TRP, and perform communications with the first TRP and the second TRP based on the at least two TCI states.

### BRIEF DESCRIPTION OF THE DRAWINGS

Aspects of the disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method for a UE for beam indication in MTRP according to an example implementation of the present disclosure.

FIG. 2 is a block diagram illustrating a node for wireless communication according to an example implementation of the present disclosure.

### DESCRIPTION

The acronyms in the present application are defined as follows, unless otherwise specified:

| Acronym | Full name |
|---|---|
| 3GPP | 3^{rd} Generation Partnership Project |
| 5G | 5^{th} generation |
| Alt | Alternative |
| BFR | Beam Failure Recovery |
| BFRQ | Beam Failure Recovery Request |
| BFRR | Beam Failure Recovery Response |
| BL | Band-Limited |
| BLER | Block Error Rate |
| BS | Base Station |
| BWP | Bandwidth Part |
| CB | Contention-Based |
| CCCH | Common Control Channel |
| CE | Control Element |
| CF | Contention-Free |
| CG | Configured grant |
| CG-DFI | CG downlink feedback information |
| CG-UCI | CG uplink control information |
| CLI | Cross Link Interference |
| CORESET | Control Resource Set |
| CP | Control Plane |
| CP-EDT | Control Plane-Early Data Transmission |
| CRI | CSI-RS Resource Index |
| C-RNTI | Cell Radio Network Temporary Identifier |
| CSI | Channel State Information |
| CSI-RS | Channel State Information based Reference Signal |
| CSI-RSRP | Channel State Information based Reference Signal Received |
| | Power |
| CU | Central Unit |
| DCI | Downlink Control Information |
| DL | Downlink |
| DU | Distributed Unit |
| EDT | Early Data Transmission |
| eNB | evolved Node B |
| gNB | gNodeB |
| HARQ | Hybrid Automatic Repeat request |
| LTE | Long Term Evolution |
| MAC | Medium Access Control |
| MIB | Master Information Block |
| MSG | Message |
| MTRP | Multi-Transmission and Reception Point |
| NBI | New Beam Identification |
| NCB | New Candidate Beam |
| NR | New RAT/Radio |
| NW | Network |
| PCell | Primary Cell |
| PCI | Physical Cell ID |
| PDCCH | Physical Downlink Control Channel |
| PDSCH | Physical Downlink Shared Channel |
| PDU | Packet Data Unit |
| PHY | Physical |
| PRACH | Physical Random Access Channel |
| PSCell | Primary Secondary Cell |
| PTAG | Primary TAG |
| PUCCH | Physical Uplink Control Channel |
| PUR | Preconfigured Uplink Resource |
| RA | Random Access |
| RACH | Random Access Channel |
| RAPID | Random Access Preamble Index |
| RAR | Random Access Response |
| RA-RNTI | Random Access Radio Network Temporary Identifier |
| RRC | Radio Resource Control |
| RS | Reference Signal |
| RSRP | Reference Signal Received Power |
| RX | Reception |
| SCell | Secondary Cell |
| SDU | Service Data Unit |
| SINR | Signal to Interference plus Noise Ratio |
| SRS | Sounding Reference Signal |
| STAG | Secondary TAG |
| SpCell | Special Cell |
| SS | Synchronization Signal |
| SSB | Synchronization Signal B lock |
| SS-RSRP | Synchronization Signal-Reference Signal Received Power |
| SUL | Supplementary Uplink |
| TA | Timing Advance or Time Alignment |
| TAG | Time Alignment Group |
| TB | Transport Block |
| TBS | Transport Block Size |
| TCI | Transmission Configuration Indication |
| TRP | Transmission and Reception Point |
| TRPG | TRP group |
| TS | Technical Specification |
| TTI | Transmission Time Interval |
| TX | Transmission |
| UCI | Uplink Control Information |
| UE | User Equipment |
| UL | Uplink |
| UL-SCH | Uplink Shared Channel |
| UP | User Plane |
| UP-EDT | User Plane-Early Data Transmission |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art. Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the so-disclosed combination, group, series or equivalent. The expression “at least one of A, B and C” or “at least one of the following: A, B and C” means “only A, or only B, or only C, or any combination of A, B and C.”

For the purposes of explanation and non-limitation, specific details such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof. A software implementation may include computer executable instructions stored on a computer readable medium such as memory or other type of storage devices. One or more microprocessors or general-purpose computers with communication processing capability may be programmed with corresponding executable instructions and perform the disclosed network function(s) or algorithm(s). The microprocessors or general-purpose computers may include Application-Specific Integrated Circuits (ASICs), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure.

The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN), typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

A BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to a node B (NB) in the UMT S, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage. Each cell (often referred to as a serving cell) may provide services to one or more UEs within its radio coverage such that each cell schedules the DL and optionally UL resources to at least one UE within its radio coverage for DL and optionally UL packet transmissions. The BS can communicate with one or more UEs in the radio communication system via the plurality of cells. A cell may allocate sidelink (SL) resources for supporting Proximity Service (ProSe) or Vehicle to Everything (V2X) service. Each cell may have overlapped coverage areas with other cells.

As discussed above, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3rd Generation Partnership Project (3GPP) may serve as a baseline for an NR waveform. The scalable OFDM numerology such as adaptive sub-carrier spacing, channel bandwidth, and Cyclic Prefix (CP) may also be used. Additionally, two coding schemes are considered for NR, specifically Low-Density Parity-Check (LDPC) code and Polar Code. The coding scheme adaption may be configured based on channel conditions and/or service applications.

Moreover, it is also considered that in a transmission time interval TX of a single NR frame, downlink (DL) transmission data, a guard period, and uplink (UL) transmission data should at least be included, where the respective portions of the DL transmission data, the guard period, and the UL transmission data should also be configurable, for example, based on the network dynamics of NR. In addition, sidelink resources may also be provided in an NR frame to support ProSe services.

In addition, the terms “system” and “network” herein may be used interchangeably. The term “and/or” herein is only an association relationship for describing associated objects and represents that these relationships may exist. For example, A and/or B may indicate that: A exists alone, A and B exist at the same time, or B exists alone.

Examples of some selected terms are provided as follows.

Base Station (BS): A network central unit or a network node in NR which may be used to control one or multiple TRPs associated with one or multiple cells. The communication between the BS and the TRP(s) may be via fronthaul. The BS may be referred to as a central unit (CU), an eNB, a gNodeB (gNB), or a NodeB.

Transmission and Reception Point (TRP): A TRP may provide the network coverage and directly communicate with the UEs. The TRP may be referred to as a distributed unit (DU) or a network node.

Cell: A cell may be composed of one or multiple associated TRPs (e.g., the coverage of the cell may be composed of the coverage of all associated TRP(s)). A cell may be controlled by a BS. A cell may be referred to as a TRP group (TRPG).

Serving beam: A serving beam for a UE may be a beam generated by a network node (e.g., a TRP) which may be configured to be used to communicate with the UE (e.g., for transmission and/or reception).

Candidate beam: A candidate beam for a UE may be a candidate of a serving beam. The serving beam may be a candidate beam. In some implementations, the serving beam may not be a candidate beam.

Early Data Transmission (EDT): Allow an uplink data transmission optionally followed by a downlink data transmission during the random access procedure as specified in the 3GPP TS 36.300. The S1 connection may be established or resumed upon reception of the uplink data and may be released or suspended along with the transmission of the downlink data. The EDT may refer to both a CP-EDT and an UP-EDT.

Transmission using preconfigured uplink resource (PUR): Allow an uplink data transmission using PUR from RRC_IDLE mode as specified in the 3GPP TS 36.300. The transmission using the PUR may refer to both a CP transmission using PUR and an UP transmission using PUR.

A UE may be configured with and/or served by a network in a serving cell. The UE may (be configured to) communicate with the network in the serving cell. The UE may be configured with one or more serving cells, which may include the using serving cell. The UE may be activated or be indicated to activate one or more serving cells, which may include the using serving cell. The UE may be configured and/or indicated one or more BWPs. The UE may be indicated and/or configured a BWP (in the serving cell).

The BWP may be activated as an active BWP. The BWP may be referred to as an active BWP. The BWP may be an active DL BWP. The BWP may be an active UL BWP. The BWP may be an initial BWP. The BWP may be a default BWP. The BWP may be a dormant BWP. The HE may be in RRC_CONNECTED state. The UE may be in RRC_INACTIVE state. The UE may be in RRC_IDLE state.

The UE may perform a DL reception from and/or an UL transmission to a first TRP. The UE may perform a DL reception from and/or an UL transmission to a second TRP. The first TRP may be located in the serving cell. The second TRP may be located in the serving cell. The second TRP may be located in a neighboring cell. The second TRP may be located in a neighboring cell, which may be a cell with a PCI different from that of the serving cell.

The UE may comprise or be equipped with one or more panels. Some or all of the one or more panels may be used and/or activated for the DL reception (performed at the same time or same time interval). Some or all of the one or more panels may be used and/or activated for the UL transmission (performed at the same time or same time interval).

The set of used and/or activated panels for DL reception may be (partially) the same as the set of used and/or activated panels for the UL transmission. The set of used and/or activated panels for DL reception may be (partially) different from the set of used and/or activated panels for the UL transmission.

The UE may be configured, indicated or may derive one or more (value of) TRP identifiers. A TRP identifier may be associated with a TRP. A DL transmission associated with a TRP identifier may mean that the DL transmission may be transmitted from a TRP associated with the TRP identifier (value). A UL transmission associated with a TRP identifier may mean that the UL transmission may be transmitted to a TRP associated with the TRP identifier (value). A (value of) TRP identifier may be associated with a CORESETPoolIndex, a value (candidate) of a CORESETPoolIndex, dataScramblingIdentityPDSCH, dataScramblingldentityPDSCH2-r16 or PUCCH-ResourceGroup-r16.

The UE may be configured, indicated or may derive one or more (value of) panel identifier(s). A panel identifier may be associated with a panel (of the UE). A DL transmission associated with a panel identifier may mean that the DL transmission may be received by a (DL) panel associated with the panel identifier (value). A UL transmission associated with a panel identifier may mean the UL transmission may be transmitted by a (UL) panel associated with the panel identifier (value). A panel identifier may be associated with a SRS resource set index, or a (candidate) value of a SRS resource set index.

The UE may be configured, indicated or may derive a first TRP identifier (value). The UE may be configured, indicated or may derive a second TRP identifier (value). The UE may be configured, indicated or may derive a first panel identifier (value). The UE may be configured, indicated or may derive a second panel identifier (value).

A joint TCI state may be referred to or replaced with at least one of the following (a)-(d):
(a) a beam applicable for both DL and UL transmission (e.g., DL or UL channel, DL or UL RS),
(b) a spatial filter for transmission and/or reception,
(c) spatial parameters for transmission and/or reception,
(d) a spatial relationship for transmission and/or reception,
(e) a spatial assumption for transmission and/or reception.

A joint TCI state may be referred to or replaced with a common TCI state or a unified TCI state. A UL TCI state may be referred to or replaced with at least one of a UL beam, a spatial relation, a spatial transmission filter, a transmission precoder, spatial parameters, a the spatial relationship. A DL TCI state may be referred to or replaced with at least one of a TCI (only) applicable for DL channel(s) or RS(s), a TCI associated with QCL type-D, a QCL assumption, a DL beam, a spatial reception filter, spatial parameters, a spatial relationship, and a spatial assumption.

A TCI pool (e.g., joint TCI pool, UL TCI pool, DL TCI pool) may be referred to or stand for a (RRC) configuration or a list, which may include or contain one or more TCI (indexes). A TCI may be referred to or replaced with a TCI state. A TCI pool may be referred to or replaced with a TCI state pool.

AUL TCI may be referred to or replaced with a UL-only TCI, which may be (only) applied for indicating the following (a)-(f) for UL transmission:
(a) a UL beam,
(b) a spatial relation,
(c) a spatial transmission filter,
(d) a transmission precoder,
(e) spatial parameters,
(f) a spatial relationship.

ADL TCI may be referred to or replaced with a DL-only TCI, which may be (only) applied for indicating the following (a)-(h) for UL transmission:
(a) a TCI (only) applicable for DL channel(s) or RS(s),
(b) a TCI associated with QCL type-D,
(c) a QCL assumption,
(d) a DL beam,
(e) a spatial reception filter,
(f) spatial parameters,
(g) a spatial relationship,
(h) a spatial assumption.

An expression of “X/Y” may include meaning of “X or Y.” An expression of “X/Y” may include meaning of “X and Y” An expression of “X/Y” may include meaning of “X and/or Y” An expression of “(A) B” or “B (A)” may include concept of “only B.” An expression of “(A) B” or “B (A)” may include concept of “A+B” or “B+A.”

A panel may mean that an antenna (port) group or an antenna (port) set. There may be more than one DL/UL beam associated with one panel. When one transmitting node (UE or NW) is performing a transmission via a panel, only one beam associated with the panel may be used to perform the transmission. For a transmitter comprising more than one panel (e.g., two panels), it may happen that two beams associated with the two panels respectively are used to perform a transmission.

A TRP identifier may mean or be referred to a (candidate) value of a TRP identifier. The first TRP identifier may be a first candidate value of a TRP identifier or a first TRP identifier value. The second TRP identifier may be a second candidate value of a TRP identifier or a second TRP identifier value.

A panel identifier may mean or be referred to a (candidate) value of a panel identifier. The first panel identifier may be a first candidate value of a panel identifier or a first panel identifier value. The second panel identifier may be a second candidate value of a panel identifier or a second panel identifier value.

A TCI field may mean or be referred to a field used or applied or repurposed to indicate one or more TCI states.

A joint type/mode or a joint TCI state type/mode may mean or be referred to at least one of the following (a) and (b): (a) the TCI field(s) or the indicated TCI state(s) in a DCI format may refer/map to one of the joint TCI state pool, the DL TCI state pool or the UL TCI state pool, and (b) the beam indication(s) or the indicated TCI state(s) may be applied for both transmitting UL transmission and/or receiving DL transmission.

A separate type/mode or a separate TCI state type/mode may mean or be referred to at least one of the following (a) and (b): (a) the TCI field(s) or the indicated TCI state(s) in a DCI format may refer/map to one of the joint TCI state pool, the DL TCI state pool or the UL TCI state pool, and (b) the beam indication(s) or the indicated TCI state(s) may be applied either for (only) transmitting UL transmission or (only) receiving DL transmission.

A UL type/mode or a UL-only TCI state type/mode may mean or be referred to at least one of the following (a) and (b): (a) the TCI field(s) or the indicated TCI state(s) in a DCI format may refer/map to the UL TCI state pool (joint TCI state pool), and (b) the beam indication(s) or the indicated TCI state(s) may be applied for (only) transmitting UL transmission.

A DL type/mode or a DL-only TCI state type/mode may mean or be referred to at least one of the following (a) and (b): (a) the TCI field(s) or the indicated TCI state(s) in a DCI format may refer/map to DL TCI state pool (joint TCI state pool), and (b) the beam indication(s) or the indicated TCI state(s) may be applied for (only) receiving DL transmission.

When a procedure or description is related to a serving cell, it may mean the procedure or description is related to an active (DL/UL) BWP in the serving cell.

A UE may monitor and/or receive one or more beam indication(s). A beam indication may carry or indicate a TCI field. A beam indication may be a (scheduling) DCI. The UE may monitor and/or receive one or more joint TCIs. The UE may monitor and/or receive one or more UL TCIs. The UE may monitor and/or receive one or more DL TCIs.

A beam indication may be or may comprise or may indicate at least one of the following (a)-(c):
(a) a beam indication applied for both receiving DL transmission and/or transmitting UL transmission,
(b) a beam indication applied for (only) transmitting UL transmission,
(c) a beam indication applied for (only) receiving DL transmission.

A beam indication applied for both receiving DL transmission and/or transmitting UL transmission may indicate or be derived from or associated with a joint TI state.

A beam indication applied for (only) transmitting UL transmission may indicate or be derived from or associated with at least one of the following (a)-(c):
(a) a UL TCI state,
(b) a joint TCI state,
(c) a DL TCI state.

If the beam indication applied for (only) transmitting UL transmission indicates or is derived from or is associated with (b) the joint TCI state, the UE may discard/ignore DL RX parameters obtained from the joint TCI state. The UE may derive, from the joint TCI state, the beam indication applied for (only) transmitting UL transmission, when (or if) the UE is indicated by a higher layer signaling (e.g., MAC-CE or RRC).

A beam indication applied for (only) receiving DL transmission may indicate or be derived from or associated with at least one of the following (a)-(c):
(a) a DL TCI state,
(b) a joint TCI state,
(c) a UL TCI state.

If the beam indication applied for (only) receiving DL transmission indicates or is derived from or is associated with (b) the joint TCI state, the UE may discard/ignore UL TX parameters obtained from the joint TCI state. The UE may derive, from the joint TCI state, the beam indication applied for (only) receiving DL transmission, when (or if) the UE is indicated by a higher layer signaling (e.g., MAC-CE or RRC).

A beam indication applied for both receiving DL transmission and/or transmitting UL transmission may be applicable to at least one of the following DL/UL transmissions (a)-(p):
(a) PDSCH,
(b) PDSCH scheduled by CORESET #0,
(c) PDSCH exclusive of those scheduled by CORESET #0,
(d) PDCCH,
(e) PDCCH from CORESET #0,
(f) PDCCH exclusive of those from CORESET #0,
(g) PDCCH not for carrying feedback/acknowledge information,
(h) DL RS (e.g., DMRS, PTRS, CSI-RS, PRS, SSB),
(i) PUSCH,
(j) PUSCH carrying certain UCI (e.g., HARQ-ACK),
(k) PUSCH not carrying certain UCI (e.g., HARQ-ACK),
(l) PUCCH,
(m) PUCCH carrying certain UCI (e.g., HARQ-ACK),
(n) PUCCH not carrying certain UCI (e.g., HARQ-ACK),
(o) UL RS (e.g., DMRS, PTRS, SRS, PRS),
(p) PRACH.

A beam indication applied for (only) transmitting UL transmission may be applicable to at least one of the following UL transmissions (a)-(h):
(a) PUSCH,
(b) PUSCH carrying certain UCI (e.g., HARQ-ACK),
(c) PUSCH not carrying certain UCI (e.g., HARQ-ACK),
(d) PUCCH,
(e) PUCCH carrying certain UCI (e.g., HARQ-ACK),
(f) PUCCH not carrying certain UCI (e.g., HARQ-ACK),
(g) UL RS (e.g., DMRS, PTRS, SRS, PRS),
(h) PRACH.

A beam indication applied for (only) receiving DL transmission may be applicable to at least one of the following DL transmissions (a)-(h).
(a) PDSCH,
(b) PDSCH scheduled by CORESET #0,
(c) PDSCH exclusive of those scheduled by CORESET #0,
(d) PDCCH,
(e) PDCCH from CORESET #0,
(f) PDCCH exclusive of those from CORESET #0,
(g) PDCCH not for carrying feedback/acknowledge information,
(h) DL RS (e.g., DMRS, PTRS, CSI-RS, PRS, SSB).

A joint TI state may indicate or include one or more RX parameters for receiving DL transmission and/or one or more TX parameters for transmitting UL transmission. The joint TCI state may comprise/indicate/provide at least a first RS. The first RS in the joint TCI state may be used to derive an DL/UL beam or spatial relation or spatial parameter for transmitting UL transmission and/or receiving DL transmission. The joint TCI state may be applied for receiving one or more DL channels and/or one or more DL signals. The joint TCI state may be applied for transmitting one or more UL channels and/or one or more UL signals. The joint TCI may indicate the UE to use the same spatial parameters for receiving one or more DL channels/signals and for transmitting one or more UL channels/signals.

The UE may be configured with one or more joint TCI states. The UE may receive a first MAC-CE. The first MAC-CE may be used/applied for activating one or more joint TCI states among the one or more configured joint TCI states. The first MAC-CE may be used/applied for indicating that one or more joint TCI states among the one or more configured joint TCI states map to one or more TCI codepoints in a TCI field of a DCL The first MAC-CE may be used/applied for indicating that one or more joint TCI states among the one or more configured joint TCI states may be used/applied for receiving DL transmission and/or transmitting UL transmission (if further indicated).

A UL TCI state may indicate or include one or more TX parameters (only) for transmitting UL transmission. The UL TCI state may comprise/indicate/provide at least a second RS. The second RS in a UL TCI state may be used to derive an UL beam or spatial relation or spatial parameter for transmitting UL transmission (and preferably receiving DL transmission). The UL TCI state may be applied for transmitting one or more UL channels and/or one or more UL signals. When indicated a UL TCI state, the HE may use or apply different spatial parameters for receiving one or more DL channels/signals and for transmitting one or more UL channels/signals. The separate UL/DL spatial parameters may be applied when joint TCI state and UL TCI state are indicated at the same time or sequentially. The separate UL/DL spatial parameters may be applied when DL TCI state and UL TCI state are indicated at the same time or sequentially.

The UE may be configured with one or more UL TCI states. The UE may receive a second MAC-CE. The second MAC-CE may be used/applied for activating one or more UL TCI states among the one or more configured UL TCI states. The second MAC-CE may be used/applied for indicating that one or more UL TCI states among the one or more configured UL TCI states map to one or more TCI codepoints in a TCI field of a DCI. The second MAC-CE may be used/applied for indicating that one or more UL TCI states among the one or more configured UL TCI states can be used/applied for transmitting UL transmission (if further indicated).

A DL TCI state may indicate or include one or more RX parameters (only) for receiving DL transmission. The DL TCI state may comprise/indicate/provide at least a third RS. The third RS in a DL TCI state may be used to derive an DL beam or spatial relation or spatial parameter for receiving DL transmission (and preferably transmitting UL transmission). The DL TCI state may be applied for receiving one or more DL channels and/or one or more DL signals. When indicated a DL TCI state, the UE may use or apply different spatial parameters for receiving one or more DL channels/signals and for transmitting one or more UL channels/signals. The separate UL/DL spatial parameters may be applied when joint TCI state and DL TCI state are indicated at the same time or sequentially. The separate UL/DL spatial parameters may be applied when DL TCI state and UL TCI state are indicated at the same time or sequentially.

The UE may be configured with one or more DL TCI states. The UE may receive a third MAC-CE. The third MAC-CE may be used/applied for activating one or more DL TCI states among the one or more DL TCI states. The third MAC-CE may be used/applied for indicating that one or more DL TCI states among the one or more configured DL TCI states map to one or more TCI codepoints in a TCI field of a DCI. The third MAC-CE may be used/applied for indicating that one or more DL TCI states among the one or more configured joint TCI states may be used/applied for receiving DL transmission and/or transmitting UL transmission (if further indicated).

Two or all of the first MAC-CE, the second MAC-CE and the third MAC-CE may be the same MAC-CE or the same MAC-CE format.

The first RS may be at least one of the following (a)-(q):
(a) SSB,
(b) CSI-RS,
(c) CSI-RS for tracking,
(d) CSI-RS for computing L1-RSRP and/or L1-SINR,
(e) CSI-RS for mobility,
(f) DL PRS,
(g) DL DMRS,
(h) DL PTRS,
(i) SRS,
(j) SRS for beam management,
(k) SRS for codebook based transmission,
(l) SRS for non-codebook based transmission,
(m) SRS for antenna switching,
(n) SRS for carrier management,
(o) UL PRS,
(p) UL DMRS,
(q) UL PTRS.

The second RS may be at least one of the following (a)-(q):
(a) SSB,
(b) CSI-RS,
(c) CSI-RS for tracking,
(d) CSI-RS for computing L1-RSRP and/or L1-SINR,
(e) CSI-RS for mobility,
(f) DL PRS,
(g) DL DMRS,
(h) DL PTRS,
(i) SRS,
(j) SRS for beam management,
(k) SRS for codebook based transmission,
(l) SRS for non-codebook based transmission,
(m) SRS for antenna switching,
(n) SRS for carrier management,
(o) UL PRS,
(p) UL DMRS,
(q) UL PTRS.
The third RS may be at least one of the following (a)-(q):
(a) SSB,
(b) CSI-RS,
(c) CSI-RS for tracking,
(d) CSI-RS for computing L1-RSRP and/or L1-SINR,
(e) CSI-RS for mobility,
(f) DL PRS,
(g) DL DMRS,
(h) DL PTRS,
(i) SRS,
(j) SRS for beam management,
(k) SRS for codebook based transmission,
(l) SRS for non-codebook based transmission,
(m) SRS for antenna switching,
(n) SRS for carrier management,
(o) UL PRS,
(p) UL DMRS,
(q) UL PTRS.

The one or more RX parameters may include information related to QCL assumption and/or spatial parameter/relation (which may be used as the beam indication, or channel characteristics derivation, e.g., Doppler shift, Doppler delay, average delay, delay spread). The one or more TX parameters may include information related to QCL assumption and/or spatial parameter/relation (which may be used as the UL beam indication), UL power control, pathloss RS, UL timing/TA, information/identifier related to transmitting panel.

The UE may be configured with a joint TCI state pool. The joint TCI state pool may include/comprise one or more joint TCI states. The UE may be configured with a UL TCI state pool. The UL TCI state pool may include/comprise one or more UL TCI states. The UE may be configured with a UL TCI state pool, where at least one beam indication (or UL TCI state) applied for (only) transmitting UL transmission is not derived from the joint TCI state(s). The UE may be configured with a DL TCI state pool. The DL TCI state pool may include/comprise one or more DL TCI states. The UE may be configured a DL TCI state pool, where at least one beam indication (or DL TCI state) applied for (only) receiving DL transmission is not derived from the joint TCI state(s).

The UE may be configured with a first joint TCI state pool. The UE may be configured with a second joint TCI state pool. The first joint TCI state pool may be associated with the first (value of) TRP identifier. The second joint TCI state pool may be associated with the second (value of) TRP identifier. The first joint TCI state pool may comprise the first (value of) TRP identifier. The second joint TCI state pool may comprise the second (value of) TRP identifier. The first joint TCI state pool may be configured under a configuration including the first (value of) TRP identifier. The second joint TCI state pool may be configured under a configuration including the second (value of) TRP identifier.

The UE may be configured with a first UL TCI state pool. The UE may be configured with a second UL TCI state pool. The first UL TCI state pool may be associated with the first (value of) TRP identifier. The second UL TCI state pool may be associated with the second (value of) TRP identifier. The first UL TCI state pool may comprise the first (value of) TRP identifier. The second UL TCI state pool may comprise the second (value of) TRP identifier. The first UL TCI state pool may be configured under a configuration including the first (value of) TRP identifier. The second UL TCI state pool may be configured under a configuration including the second (value of) TRP identifier.

The UE may be configured with a first DL TCI state pool. The UE may be configured with a second DL TCI state pool. The first DL TCI state pool may be associated with the first (value of) TRP identifier. The second DL TCI state pool may be associated with the second (value of) TRP identifier. The first DL TCI state pool may comprise the first (value of) TRP identifier. The second DL TCI state pool may comprise the second (value of) TRP identifier. The first DL TCI state pool may be configured under a configuration including the first (value of) TRP identifier. The second DL TCI state pool may be configured under a configuration including the second (value of) TRP identifier.

The type of the second RS in the UL TCI state may (only allowed to) be a second UL RS. The UE may not expect to be indicated/configured that a UL TCI state pool comprises a UL TCI state indicating/comprising/providing the second RS, where the second RS is not set as the second UL RS. The network may not (be allowed to) indicate/configure the UE that a UL TCI state pool comprises a UL TCI state indicating/comprising/providing the second RS, where the second RS is not set as the second UL RS.

When (or if) (i) the joint TCI state pool and the UL TCI state pool are the same, and/or (ii) the UL TCI state pool is a subset of the joint TCI state pool, and/or (iii) the joint TCI state pool include the UL TCI state pool, (a) the type of the RS in the UL TCI state may (only allowed to) be SRS, and/or (b) the UE may not expect to be indicated/configured that a UL TCI state pool comprises a UL TCI state indicating/comprising/providing the second RS, where the second RS is not set as the second UL RS, and/or (c) the network may not (be allowed to) indicate/configure the UE that a UL TCI state pool comprises a UL TCI state indicating/comprising/providing the second RS, where the second RS is not set as the second UL RS.

The second UL RS may be at least one of the following (a)-(j):
(a) SRS,
(b) SRS for beam management,
(c) SRS for codebook based transmission,
(d) SRS for non-codebook based transmission,
(e) SRS for antenna switching,
(f) SRS for carrier management,
(g) SRS for CLI,
(h) UL PRS,
(i) UL DMRS,
(j) UL PTRS.

The first RS in the joint TCI state may not (be allowed to) be a first UL RS. When (or if) a joint TCI state is used/applied for both receiving DL transmission and/or transmitting UL transmission, the first RS in the joint TCI state may not (be allowed to) be a first UL RS. When (or if) a joint TCI state is used/applied for (only) receiving DL transmission, the first RS in the joint TCI state may not (be allowed to) be a first UL RS. When (or if) the first RS in the joint TCI state is a first UL RS, the joint TCI state may not (be allowed to) be used/applied for both receiving DL transmission and/or transmitting UL transmission. When (or if) the first RS in the joint TCI state is a first UL RS, the joint TCI state may not (be allowed to) be used/applied for (only) receiving DL transmission.

The first UL RS may be at least one of the following (a)-(i):
(a) SRS,
(b) SRS for beam management,
(c) SRS for codebook based transmission,
(d) SRS for non-codebook based transmission,
(e) SRS for antenna switching,
(f) SRS for carrier management,
(g) UL PRS,
(h) UL DMRS,
(i) UL PTRS.

When or upon the UE receives a beam indication, the UE may determine the purpose/type of the beam indication. For example, the UE may determine the received beam indication is applied for both receiving DL transmission and/or for transmitting UL transmission, based on a rule or other indication. For example, the UE may determine the received beam indication is applied (only) for transmitting UL transmission, based on a rule or other indication. For example, the UE may determine the received beam indication is applied (only) for receiving DL transmission, based on a rule or other indication.

The UE may receive a beam indication in slot p. The UE may receive a beam indication in slot q. The slot q may be located after the slot p. There may not be other beam indication received or transmitted between the slot p and the slot q. The UE may not expect that the beam indication in the slot q may be or may indicate a TCI state applied for (only) receiving DL transmission, when (or if) the beam indication in the slot p is or indicates a TCI state applied for both receiving DL transmission and/or transmitting UL transmission. The slot p and the slot q may be referred to or replaced with other time scale unit (e.g., mini-slot, subframe or symbol).

The UE may be configured with and/or activated a first serving cell. The UE may be configured and/or activated a second serving cell. The UE may monitor and/or receive the beam indication in the first serving cell. The beam indication may be applied for the second serving cell.

How the UE determines the second serving cell may be according to at least one of the following (a)-(c):
(a) a scheduled serving cell of a scheduled PDSCH or PUSCH or DL/UL RS transmission by the DCI associated with the beam indication, if the beam indication schedules one,
(b) a scheduled serving cell, if the beam indication schedules PDSCH orPUSCH or DL/UL RS transmission, where the scheduled serving cell may be indicated by the beam indication,
(c) (indicated value) of a carrier indicator field (CIF).

A carrier indicator field may indicate which serving cell is the second serving cell. A carrier indicator field may indicate which serving cell is the second serving cell, when the beam indication does not schedule a PDSCH or a PUSCH or a DL/UL transmission.

After or upon the UE receives or is indicated a TCI state (or beam indication) applied for both receiving DL transmission and/or transmitting UL transmission, the UE may apply the TCI state (or beam indication) applied for both receiving DL transmission and/or transmitting UL transmission starting from the first/earliest (available) DL/UL slot that is after slot n1 plus a first application time.

After or upon the UE receives or is indicated a TCI state (or beam indication) applied for (only) transmitting UL transmission, the UE may apply the TCI state applied for (only) transmitting UL transmission starting from the first/earliest (available) DL/UL slot that is after slot n2 plus a second application time.

After or upon the UE receives or is indicated a TCI state (or beam indication) applied for (only) receiving DL transmission, the UE may apply the TCI state (or beam indication) applied for (only) receiving DL transmission starting from the first/earliest (available) DL/UL slot that is after slot n3 plus a third application time.

The slot n1 may be a slot, where the UE may receive the TCI state (or beam indication) applied for both receiving DL transmission and/or transmitting UL transmission, and/or transmit the acknowledgement of the TCI state (or beam indication) applied for both receiving DL transmission and/or transmitting UL transmission.

The slot n2 may be a slot, where the UE may receive the TCI state (or beam indication) applied for (only) transmitting UL transmission, and/or transmit the acknowledgement of the TCI state (or beam indication) applied for (only) transmitting UL transmission.

The slot n3 may be a slot, where the UE may receive the TCI state (or beam indication) applied for (only) receiving DL transmission, and/or transmit the acknowledgement of the TCI state (or beam indication) applied for (only) receiving DL transmission.

The first application time may be associated with or derived from the second application time and the third application time. For example, the first application time may be maximum application time between the second application time and the third application time.

When (or if) a beam indication is associated with a TRP related identifier (value) and/or carried/scheduled by a PDCCH associated with a TRP related identifier (value), the UE may (only) apply the beam indication for receiving DL transmission and/or transmitting UL transmission, where the DL transmission and/or UL transmission are associated with the same TRP related identifier (value).

In some implementations, the beam indication may be at least one of the following (a)-(g):
(a) DCI format 1_1,
(b) DCI format 1_2,
(c) DCI format 0_1,
(d) DCI format 0_2,
(e) DCI format 1_0,
(f) DCI format 0_0,
(g) a common or group common DCI format.

The beam indication may be a DCI format with DL data scheduling. The beam indication may be DCI format 1_1 and/or DCI format 1_2, which schedules valid or actual DL data assignment. The beam indication may be a DCI format without DL data scheduling. One or more DCI fields of the beam indication may be modified or reused from (that of) DCI format 1_1 and/or DCI format 1_2. One or more DCI fields of the beam indication may be modified or reused from (that of) DCI format 1_1 and/or DCI format 1_2 for DL data scheduling. The beam indication may be DCI format 1_1 and/or DCI format 1_2, which does not schedule valid or actual DL data assignment. The DCI format without DL data scheduling may be derived from a DCI format with DL data scheduling, where some DCI fields related to data scheduling in the DCI format may be ignored or repurposed.

A first set of TCI states may be activated or indicated to map with one or more TCI codepoints in the beam indication. A first set of TCI states may be activated or indicated to map with one or more TCI fields in the beam indication. The first set of TCI states may be associated with the first TRP or the first TRP identifier (value). The first set of TCI states may (only) comprise TCI states from at least one of the first joint TCI state pool, the first UL TCI state pool and the first DL TCI state pool.

A second set of TCI states may be activated or indicated to map with one or more TCI codepoints in the beam indication. A second set of TCI states may be activated or indicated to map with one or more TCI fields in the beam indication. The second set of TCI states may be associated with the second TRP or the second TRP identifier (value). The second set of TCI states may (only) comprise TCI states from at least one of the second joint TCI state pool, the second UL TCI state pool and the second DL TCI state pool.

If or when the UE is indicated a TCI state, by the beam indication, from the first set of TCI states, the UE may apply the TCI state (only) for the DL transmission and/or the UL transmission, which are associated with the first (value of) TRP identifier.

If or when the UE is indicated a TCI state, by the beam indication, from the first set of TCI states, the UE may apply the TCI state (only) for the DL transmission and/or the UL transmission, which are associated with the first (value of) TRP identifier, where (i) the DL transmission may include PDCCH, PDSCH, SSB, RS (e.g., CSI-RS, DL PT-RS, DL DM-RS), and (ii) the UL transmission may include PUCCH, PUSCH, PRACH, RS (e.g., SRS, UL PT-RS, UL DM-RS).

If or when the UE is indicated a TCI state, by the beam indication, from the first set of TCI states, the UE may apply the TCI state (only) for the DL transmission and/or the UL transmission, which are associated with the first (value of) TRP identifier, where:
(i) the DL transmission associated with the first (value of) TRP identifier may mean or refer to that at least one of the following (a)-(d):
(a) A PDCCH is transmitted by a CORESET configured/associated with the first (value of) TRP identifier,
(b) A PDSCH is scheduled by a PDCCH or DCI transmitted by a CORESET configured/associated with the first (value of) TRP identifier,
(c) A P/SP CSI-RS (resource set) is configured in a CSI-RS configuration including or being associated with the first (value of) TRP identifier,
(d) An AP CSI-RS (resource set) is triggered by a PDCCH or DCI transmitted by a CORESET configured/associated with the first (value of) TRP identifier, and
(ii) the UL transmission associated with the first (value of) TRP identifier may mean or refer to that at least one of the following (a)-(f):
(a) A PUCCH is scheduled by a PDCCH or DCI transmitted by a CORESET configured/associated with the first (value of) TRP identifier,
(b) A PUCCH is configured in a PUCCH configuration including or being associated with the first (value of) TRP identifier,
(c) A PUSCH is scheduled by a PDCCH or DCI transmitted by a CORESET configured/associated with the first (value of) TRP identifier,
(d) A PUSCH is configured in a PUSCH configuration (e.g., configured grant) including or being associated with the first (value of) TRP identifier,
(e) A P/SP SRS (resource set) is configured in a SRS configuration including or being associated with the first (value of) TRP identifier,
(f) An AP SRS (resource set) is triggered by a PDCCH or DCI transmitted by a CORESET configured/associated with the first (value of) TRP identifier.

If or when the UE is indicated a TCI state, by the beam indication, from the second set of TCI state, the UE may apply the TCI state (only) for DL transmission and/or UL transmission, which are associated with the second (value of) TRP identifier.

If or when the UE is indicated a TCI state, by the beam indication, from the second set of TCI states, the UE may apply the TI state (only) for DL transmission and/or UL transmission, which are associated with the second (value of) TRP identifier, where: (i) the DL transmission may include PDCCH, PDSCH, SSB, RS (e.g., CSI-RS, DL PT-RS, DL DM-RS), and (ii) the UL transmission may include PUCCH, PUSCH, PRACH, RS (e.g., SRS, UL PT-RS, UL DM-RS).

If or when the UE is indicated a TCI state, by the beam indication, from the second set of TCI states, the UE may apply the TCI state (only) for the DL transmission and/or the UL transmission, which are associated with the second (value of) TRP identifier, where:
(i) the DL transmission associated with the second (value of) TRP identifier may mean or refer to that at least one of the following (a)-(d):
(a) A PDCCH is transmitted by a CORESET configured/associated with the second (value of) TRP identifier,
(b) A PDSCH is scheduled by a PDCCH or DCI transmitted by a CORESET configured/associated with the second (value of) TRP identifier,
(c) A P/SP CSI-RS (resource set) is configured in a CSI-RS configuration including or being associated with the second (value of) TRP identifier,
(d) An AP CSI-RS (resource set) is triggered by a PDCCH or DCI transmitted by a CORESET configured/associated with the second (value of) TRP identifier, and
(ii) the UL transmission associated with the second (value of) TRP identifier may mean or refer to that at least one of the followings:
(a) A PUCCH is scheduled by a PDCCH or DCI transmitted by a CORESET configured/associated with the second (value of) TRP identifier,
(b) A PUCCH is configured in a PUCCH configuration including or being associated with the second (value of) TRP identifier,
(c) A PUSCH is scheduled by a PDCCH or DCI transmitted by a CORESET configured/associated with the second (value of) TRP identifier,
(d) A PUSCH is configured in a PUSCH configuration (e.g., configured grant) including or being associated with the second (value of) TRP identifier,
(e) A P/SP SRS (resource set) is configured in a SRS configuration including or being associated with the second (value of) TRP identifier,
(f) An AP SRS (resource set) is triggered by a PDCCH or DCI transmitted by a CORESET configured/associated with the second (value of) TRP identifier.

The UE may not expect or the network may not allow to indicate that a TCI codepoint in a TCI field maps to one or more TCI state(s), where:
(i) at least one of the one or more TCI states may be at least one of the following (a)-(f):
(a) applied for both receiving DL transmission and/or transmitting UL transmission associated with the first TRP or the first TRP identifier (value),
(b) applied for (only) receiving DL transmission associated with the first TRP or the first TRP identifier (value),
(c) applied for (only) transmitting UL transmission associated with the first TRP or the first TRP identifier (value),
(d) among the first joint TCI state pool,
(e) among the first UL TCI state pool,
(f) among the first DL TCI state pool, and
(ii) at least another one of the one or more TCI states may be at least one of the following (a)-(f):
(a) applied for both receiving DL transmission and/or transmitting UL transmission associated with the second TRP or the second TRP identifier (value),
(b) applied for (only) receiving DL transmission associated with the second TRP or the second TRP identifier (value),
(c) applied for (only) transmitting UL transmission associated with the second TRP or the second TRP identifier (value),
(d) among the second joint TCI state pool,
(e) among the second UL TCI state pool,
(f) among the second DL TCI state pool.

The UE may receive a first field. The UE may receive a DL assignment. The DL assignment may schedule one or more PDSCH transmission (occasions). The first field may be used to indicate a PDSCH transmission scheme for the one or more PDSCH transmission (occasions). The PDSCH transmission scheme may be at least one of the following (a)-(g):
(a) (only) one PDSCH transmission (occasion) are scheduled by the DL assignment, which may be transmitted by or associated with the first TRP or the second TRP.
(b) multiple PDSCH transmission (occasion) are scheduled by the DL assignment, which may be transmitted by or associated with the first TRP (only) or the second TRP (only): In this case, the multiple PDSCH transmission (occasion) may carry the same TB.
(c) SDM: In this case, (only) one PDSCH transmission (occasion) are scheduled by the DL assignment. The PDSCH transmission (occasion) may be transmitted by or associated with the first TRP and the second TRP.
(d) FDM 1: In this case, a first PDSCH transmission (occasion) and a second PDSCH transmission (occasion) are scheduled by the DL assignment. The first PDSCH transmission (occasion) and the second PDSCH transmission (occasion) may be transmitted by or associated with the first TRP and the second TRP respectively. The first PDSCH transmission (occasion) and the second PDSCH transmission (occasion) may be transmitted in FDM way. The first PDSCH transmission (occasion) and the second PDSCH transmission (occasion) may carry different part of one or more encoded bits.
(e) FDM 2: In this case, a first PDSCH transmission (occasion) and a second PDSCH transmission (occasion) are scheduled by the DL assignment. The first PDSCH transmission (occasion) and the second PDSCH transmission (occasion) may be transmitted by or associated with the first TRP and the second TRP respectively. The first PDSCH transmission (occasion) and the second PDSCH transmission (occasion) may be transmitted in FDM way. The first PDSCH transmission (occasion) and the second PDSCH transmission (occasion) may carry different one or more encoded bits.
(f) TDM within a slot: In this case, a first PDSCH transmission (occasion) and a second PDSCH transmission (occasion) are scheduled by the DL assignment. The first PDSCH transmission (occasion) and the second PDSCH transmission (occasion) may be transmitted by or associated with the first TRP and the second TRP respectively. The first PDSCH transmission (occasion) and the second PDSCH transmission (occasion) may be transmitted in TDM way within a slot.
(g) TDM across slots: In this case, one or more PDSCH transmission (occasion) are scheduled by the DL assignment. Part of the one or more PDSCH transmission (occasion) may be transmitted by or associated with the first TRP and the other part of the one or more PDSCH transmission (occasion) may be transmitted by the second TRP. The one or more PDSCH transmission (occasion) may be transmitted in TDM way across slots.

The length of the first field may be at least 3-bits. The first filed may be carried in at least one of the DL assignment, the beam indication, a MAC-CE and a RRC configuration.

The UE may receive a second field. The UE may receive a UL grant. The UL grant may schedule one or more PUSCH transmission (occasions). The second field may be used to indicate a PUSCH transmission scheme for the one or more PUSCH transmission (occasions). The PUSCH transmission scheme may be at least one of the following (a)-(d):
(a) (only) one PUSCH transmission (occasion) are scheduled by the UL grant, which may be transmitted to or associated with the first TRP or the second TRP.
(b) multiple PUSCH transmission (occasion) are scheduled by the UL grant, which may be transmitted to or associated with the first TRP (only) or the second TRP (only): In this case, the multiple PUSCH transmission (occasion) may carry the same TB.
(c) TDM within a slot: In this case, a first PUSCH transmission (occasion) and a second PUSCH transmission (occasion) are scheduled by the UL grant. The first PUSCH transmission (occasion) and the second PUSCH transmission (occasion) may be transmitted to or associated with the first TRP and the second TRP respectively. The first PUSCH transmission (occasion) and the second PUSCH transmission (occasion) may be transmitted in TDM way within a slot.
(d) TDM across slots: In this case, one or more PUSCH transmission (occasions) are scheduled by the UL grant. Part of the one or more PUSCH transmission (occasions) may be transmitted to or associated with the first TRP and the other part of the one or more PUSCH transmission (occasions) may be transmitted to or associated with the second TRP. The one or more PUSCH transmission (occasions) may be transmitted in TDM way across slots.

The length of the second field may be at least 2-bits. The first filed may be carried in at least one of the UL assignment, the beam indication, a MAC-CE and a RRC configuration.

In some implementations, the UE may receive a first beam indication. The UE may receive a second beam indication. The beam indication, the first beam indication or the second beam indication may be at least one of the following (a)-(g):
(a) DCI format 1_1,
(b) DCI format 1_2,
(c) DCI format 0_1,
(d) DCI format 0_2,
(e) DCI format 1_0,
(f) DCI format 0_0,
(g) a common or group common DCI format.

The beam indication, the first beam indication or the second beam indication may be a DCI format with DL data scheduling. The beam indication may be DCI format 1_1 and/or DCI format 1_2, which schedules valid or actual DL data assignment.

The beam indication, the first beam indication or the second beam indication may be a DCI format without DL data scheduling. One or more DCI fields of the beam indication may be modified or reused from (that of) DCI format 1_1 and/or DCI format 1_2. One or more DCI fields of the beam indication may be modified or reused from (that of) DCI format 1_1 and/or DCI format 1_2 for DL data scheduling. Preferably, the beam indication may be DCI format 1_1 and/or DCI format 1_2, which does not schedule valid or actual DL data assignment. The DCI format without DL data scheduling may be derived from a DCI format with DL data scheduling, where some DCI fields related to data scheduling in the DCI format may be ignored or repurposed.

The UE may receive the first beam indication from a CORESET associated with the first (value of) TRP identifier. The first beam indication may indicate joint TCI. The first beam indication may indicate UL-only TCI. The first beam indication may indicate DL-only TCI.

The UE may apply the first beam indication (only) for DL transmission and/or UL transmission, which are associated with the first (value of) TRP identifier, where: (i) the DL transmission may include PDCCH, PDSCH, SSB, RS (e.g., CSI-RS, DL PT-RS, DL DM-RS), and (ii) UL transmission may include PUCCH, PUSCH, PRACH, RS (e.g., SRS, UL PT-RS, UL DM-RS).

The UE may apply the first beam indication (only) for DL transmission and/or UL transmission, which are associated with the first (value of) TRP identifier, where:
(i) the DL transmission associated with the first (value of) TRP identifier may mean or refer to that at least one of the following (a)-(d):
(a) A PDCCH is transmitted by a CORESET configured/associated with the first (value of) TRP identifier,
(b) A PDSCH is scheduled by a PDCCH or DCI transmitted by a CORESET configured/associated with the first (value of) TRP identifier,
(c) A P/SP CSI-RS (resource set) is configured in a CSI-RS configuration including or being associated with the first (value of) TRP identifier,
(d) An AP CSI-RS (resource set) is triggered by a PDCCH or DCI transmitted by a CORESET configured/associated with the first (value of) TRP identifier, and
(ii) the UL transmission associated with the first (value of) TRP identifier may mean or refer to that at least one of the following (a)-(f):
(a) A PUCCH is scheduled by a PDCCH or DCI transmitted by a CORESET configured/associated with the first (value of) TRP identifier,
(b) A PUCCH is configured in a PUCCH configuration including or being associated with the first (value of) TRP identifier,
(c) A PUSCH is scheduled by a PDCCH or DCI transmitted by a CORESET configured/associated with the first (value of) TRP identifier,
(d) A PUSCH is configured in a PUSCH configuration (e.g., configured grant) including or being associated with the first (value of) TRP identifier,
(e) A P/SP SRS (resource set) is configured in a SRS configuration including or being associated with the first (value of) TRP identifier,
(f) An AP SRS (resource set) is triggered by a PDCCH or DCI transmitted by a CORESET configured/associated with the first (value of) TRP identifier.

The UE may receive the second beam indication from a CORESET associated with the second (value of) TRP identifier. The second beam indication may indicate joint TCI. The second beam indication may indicate UL-only TCI. The second beam indication may indicate DL-only TCI.

The UE may apply the second beam indication (only) for DL transmission and/or UL transmission, which are associated with the second (value of) TRP identifier, where: (i) the DL transmission may include PDCCH, PDSCH, SSB, RS (e.g., CSI-RS, DL PT-RS, DL DM-RS), and (ii) the UL transmission may include PUCCH, PUSCH, PRACH, RS (e.g., SRS, UL PT-RS, UL DM-RS).

The UE may apply the second beam indication (only) for DL transmission and/or UL transmission, which are associated with the second (value of) TRP identifier, where:
(i) the DL transmission associated with the second (value of) TRP identifier may mean or refer to that at least one of the following (a)-(d):
(a) A PDCCH is transmitted by a CORESET configured/associated with the second (value of) TRP identifier,
(b) A PDSCH is scheduled by a PDCCH or DCI transmitted by a CORESET configured/associated with the second (value of) TRP identifier,
(c) A P/SP CSI-RS (resource set) is configured in a CSI-RS configuration including or being associated with the second (value of) TRP identifier,
(d) An AP CSI-RS (resource set) is triggered by a PDCCH or DCI transmitted by a CORESET configured/associated with the second (value of) TRP identifier, and
(ii) the UL transmission associated with the second (value of) TRP identifier may mean or refer to that at least one of the following (a)-(f):
(a) A PUCCH is scheduled by a PDCCH or DCI transmitted by a CORESET configured/associated with the second (value of) TRP identifier,
(b) A PUCCH is configured in a PUCCH configuration including or being associated with the second (value of) TRP identifier,
(c) A PUSCH is scheduled by a PDCCH or DCI transmitted by a CORESET configured/associated with the second (value of) TRP identifier,
(d) A PUSCH is configured in a PUSCH configuration (e.g., configured grant) including or being associated with the second (value of) TRP identifier,
(e) A P/SP SRS (resource set) is configured in a SRS configuration including or being associated with the second (value of) TRP identifier,
(f) An AP SRS (resource set) is triggered by a PDCCH or DCI transmitted by a CORESET configured/associated with the second (value of) TRP identifier.

In some implementations, a beam indication may be a DCI format. The beam indication may be at least one of the following (a)-(g):
(a) DCI format 1_1,
(b) DCI format 1_2,
(c) DCI format 0_1,
(d) DCI format 0_2,
(e) DCI format 1_0,
(f) DCI format 0_0,
(g) a common or group common DCI format.

The DCI format may include or indicate a TCI field or a TCI state value. The DCI format may include or indicate a field. The field may indicate which TCI state pool the TCI field is referring/mapping to. For example, the field may indicate that the TCI field refers or maps to (activated) TCI states from a joint TCI state pool. For example, the field may indicate that the TCI field refers or maps to (activated) TCI states from a UL TCI state pool. For example, the field may indicate that the TCI field refers or maps to (activated) TCI states from a DL TCI state pool.

The field may indicate the purpose of the indicated TCI state value. The field may indicate the indicated TCI state value is used for both receiving DL transmission and transmitting UL transmission. The field may indicate the indicated TCI state value is used for (only) transmitting UL transmission. The field may indicate the indicated TCI state value is used for (only) receiving DL transmission.

The field may be a one-bit or two-bit field. The field may be a field prior to the TCI field. The field may be a sub-field in the TCI field. The field may be one or more bit(s) in the TCI field.

In some implementations, the beam indication may be at least one of the following (a)-(g):
(a) DCI format 1_1,
(b) DCI format 1_2,
(c) DCI format 0_1,
(d) DCI format 0_2,
(e) DCI format 1_0,
(f) DCI format 0_0,
(g) a common or group common DCI format.

The DCI format may include or indicate a TCI field or a TCI state value. The UE may receive a higher layer signaling (e.g., MAC-CE or RRC configuration). The higher layer signaling may indicate the type of TCI state pool, where (TCI field(s) in) subsequent received beam indication(s) are referring/mapping to. The higher layer signaling may indicate the purpose of TCI state indicated by subsequent received beam indication(s). For example, when indicated “joint type/mode”, the TCI field(s) may refer/map to the joint TCI state pool. For example, when indicated “UL type/mode”, the TCI field(s) may refer/map to the UL TCI state pool (or joint TCI state pool). For example, when indicated “DL type/mode”, the TCI field(s) may refer/map to the DL TCI state pool (or joint TCI state pool). For example, when indicated “separate type/mode”, the TCI field(s) may refer/map to either DL TCI state pool or UL TCI state pool. For example, when indicated “separate type/mode”, the TCI field(s) may refer/map to either joint TCI state pool or UL TCI state pool. For example, when indicated “separate type/mode”, the TCI field(s) may refer/map to either joint TCI state pool or DL TCI state pool. The effect of the higher layer signaling may last or continue until the next one higher layer signaling with the same purpose. A subsequent (received) beam indication may mean or be referred to a beam indication received after the higher layer signaling. A subsequent (received) beam indication may mean or be referred to a beam indication received during a time duration that the higher layer signaling is effective.

When (or if) the higher layer signaling (i) indicates “joint type/mode,” and/or (ii) indicates that TCI states indicated by the subsequent beam indication(s) are applied for both DL reception and UL transmission, and/or (iii) indicates a joint TCI state pool, the UE may (a) apply indicated TCI state(s) from subsequent beam indication(s) for receiving DL transmission and/or transmitting UL transmission, and (b) determine that TCI field(s) indicated/included in subsequent beam indication(s) are referring/mapping to (activated) TCI state(s) in a joint TI state pool.

When (or if) the higher layer signaling (i) indicates “separate type/mode” or “UL type/mode,” and/or (ii) indicates that TCI states indicated by the subsequent beam indication(s) are applied for (only) UL transmission, and/or (iii) indicates a joint TCI state pool or a UL TCI state pool, the UE may apply indicated TCI state(s) from subsequent beam indication(s) for (only) transmitting UL transmission, and the UE may further (a) determine that TCI field(s) indicated/included in subsequent beam indication(s) are referring/mapping to (activated) TCI state(s) in a UL TCI state pool (if the higher layer indicates a UL TCI state pool), or (b) determine that TCI field(s) indicated/included in subsequent beam indication(s) are referring/mapping to (activated) TCI state(s) in a joint TCI state pool (if the higher layer indicates a joint TI state pool). In this case, the UE may discard/ignore DL RX parameters obtained from TCI state(s) indicated by subsequent beam indication(s).

When (or if) the higher layer signaling (i) indicates “separate type/mode” or “UL type/mode,” and/or (ii) indicates that TCI states indicated by the subsequent beam indication(s) are applied for (only) UL transmission, and/or (iii) does not indicate the type of TCI state pool, the UE may (a) be indicated by subsequent beam indication(s) the type of TCI state pool, where TCI field(s) indicated by subsequent beam indication(s) is referring or mapping to, and/or (b) discard/ignore DL RX parameters obtained from TCI state(s) indicated by subsequent beam indication(s), if the beam indication indicates that a joint TCI state pool.

When (or if) the higher layer signaling (i) indicates “separate mode,” and/or (ii) does not indicate “UL type/mode” nor “DL type/mode,” and/or (iii) does not indicate that TCI states indicated by the subsequent beam indication(s) are applied for (only) UL transmission or for (only) DL transmission, and/or (iv) does not indicate the type of TCI state pool, the UE may (a) be indicated by subsequent beam indication(s) “UL type/mode,” and/or (b) be indicated by subsequent beam indication(s) the type of TC state pool, where TCI field(s) indicated by subsequent beam indication(s) is referring or mapping to, and/or (c) discard/ignore DL RX parameters obtained from TCI state(s) indicated by subsequent beam indication(s), if the beam indication indicates that a joint TCI state pool.

When (or if) the higher layer signaling (i) indicates “separate mode” or “DL mode,” and/or (ii) indicates that TCI states indicated by the subsequent beam indication(s) are applied for (only) DL reception, and/or (iii) indicates a joint TI state pool or a DL TCI state pool, the UE may (a) apply indicated TCI state(s) from subsequent beam indication(s) for (only) receiving DL transmission, and/or (b) determine that TCI field(s) indicated/included in subsequent beam indication(s) are referring/mapping to (activated) TCI state(s) in a DL TCI state pool (if the higher layer indicates that a DL TCI state pool), and/or (c) determine that TCI field(s) indicated/included in subsequent beam indication(s) are referring/mapping to (activated) TCI state(s) in a joint TCI state pool (if the higher layer indicates a joint TCI state pool). In this case, the UE may discard/ignore UL TX parameters obtained from TCI state(s) indicated by subsequent beam indication(s).

When (or if) the higher layer signaling (i) indicates “separate type/mode” or “DL type/mode,” and/or (ii) indicates that TCI states indicated by the subsequent beam indication(s) are applied for (only) DL reception, and/or (iii) does not indicate the type of TCI state pool, the UE may (a) be indicated by subsequent beam indication(s) the type of TCI state pool, where TCI field(s) indicated by subsequent beam indication(s) is referring or mapping to, and/or (b) discard/ignore UL TX parameters obtained from TCI state(s) indicated by subsequent beam indication(s), if the beam indication indicates that a joint TCI state pool.

When (or if) the higher layer signaling (i) indicates “separate type/mode,” and/or (ii) does not indicate “UL type/mode” nor “DL type/mode”, and/or (iii) does not indicate that TCI states indicated by the subsequent beam indication(s) are applied for (only) UL transmission nor for (only) DL transmission, and/or (iv) does not indicate the type of TCI state pool, the UE may (a) be indicated by subsequent beam indication(s) “DL type/mode”, and/or (b) be indicated by subsequent beam indication(s) the type of TCI state pool, where TCI field(s) indicated by subsequent beam indication(s) is referring or mapping to, and/or (c) discard/ignore UL TX parameters obtained from TCI state(s) indicated by subsequent beam indication(s), if the beam indication indicates that a joint TCI state pool.

There may be a field in the beam indication (e.g., prior to the TCI field) or a sub-field in the TCI field (e.g., in the front of the TCI field), where the field or the sub-field may be used or serve as (i) indicating TCI states with considering the TCI field or the remaining of the TCI field, and/or (ii) being absent or reserved field (when certain condition is satisfied), and/or (iii) indicating type of TCI state pool, where the TCI field is referring or mapping to.

When (or if) the MAC-CE indicates the “joint type/mode”, or indicates that the TCI states indicated by the subsequent beam indication(s) are applied for both DL reception and UL transmission, the UE may derive or determine a first bit-length, where the first bit-length is total bit length of the field plus the TCI field (or bit length of the TCI field, e.g., the sub-field plus the remaining of the TCI field.

When (or if) the MAC-CE indicates the “separate type/mode,” or indicates that the TCI states indicated by the subsequent DCI formats are applied for (only) DL reception or (only) for UL transmission, the UE may derive or determine a second bit-length, where the second bit-length is total bit length of the field plus the TCI field (or bit length of the TCI field, e.g., the sub-field plus the remaining of the TCI field).

The first bit-length and the second bit-length may be derived or determined under assumption of the same DCI format. The first bit-length and/or the second bit-length may be indicated or specified. The UE may expect that the first bit-length and the second bit-length are the same. The network may (be required to) set that the first bit-length and the second bit-length are the same. The length of the TCI field may be determined by or associated with at least one of the following (a) and (b): (a) the type of TCI state pool where the TCI field is referring or mapping to, and (b) the number or amount of activated TCI states from the referred/mapped TCI state pool.

In some implementations, the beam indication may be at least one of the following (a)-(g):
(a) DCI format 1_1,
(b) DCI format 1_2,
(c) DCI format 0_1,
(d) DCI format 0_2,
(e) DCI format 1_0,
(f) DCI format 0_0,
(g) a common or group common DCI format.

The DCI format or the beam indication may include or indicate one or more TCI field or TCI state value. One or more TCI codepoints in a TCI field may map to (separately) one or more TCI states applied for both receiving DL transmission and/or transmitting UL transmission. One or more TCI codepoints in a TCI field may map to (separately) one or more TCI states applied for both receiving DL transmission and/or transmitting UL transmission associated with the first TRP or the first TRP identifier (value). One or more TCI codepoints in a TCI field may map to (separately) one or more TCI states applied for both receiving DL transmission and/or transmitting UL transmission associated with the second TRP or the second TRP identifier (value).

One or more TCI codepoints in a TCI field may map to (separately) one or more TCI states applied for (only) transmitting UL transmission. One or more TCI codepoints in a TCI field may map to (separately) one or more TCI states applied for (only) transmitting UL transmission associated with the first TRP or the first TRP identifier (value). One or more TCI codepoints in a TCI field may map to (separately) one or more TCI states applied for (only) transmitting UL transmission associated with the second TRP or the second TRP identifier (value).

One or more TCI codepoints in a TCI field may map to (separately) one or more TCI states applied for (only) receiving DL transmission. One or more TCI codepoints in a TCI field may map to (separately) one or more TCI states applied for (only) receiving DL transmission associated with the first TRP or the first TRP identifier (value). One or more TCI codepoints in a TCI field may map to (separately) one or more TCI states applied for (only) receiving DL transmission associated with the second TRP or the second TRP identifier (value).

At least one TCI codepoint in a TCI field may map to one or more TCI states, where:
(i) at least one of the one or more TI states may be at least one of the following (a)-(f):
(a) applied for both receiving DL transmission and/or transmitting UL transmission associated with the first TRP or the first TRP identifier (value),
(b) applied for (only) receiving DL transmission associated with the first TRP or the first TRP identifier (value),
(c) applied for (only) transmitting UL transmission associated with the first TRP or the first TRP identifier (value),
(d) among the first joint TCI state pool,
(e) among the first UL TCI state pool,
(f) among the first DL TCI state pool.
(ii) at least another one of the one or more TCI states may be at least one of the following (a)-(f):
(a) applied for both receiving DL transmission and/or transmitting UL transmission associated with the first TRP or the first TRP identifier (value),
(b) applied for (only) receiving DL transmission associated with the first TRP or the first TRP identifier (value),
(c) applied for (only) transmitting UL transmission associated with the first TRP or the first TRP identifier (value),
(d) among the first joint TCI state pool,
(e) among the first UL TCI state pool,
(f) among the first DL TCI state pool.

At least one TCI codepoint in a TCI field may map to one or more TCI states, where:
(i) at least one of the one or more TCI state(s) may be at least one of the following (a)-(f):
(a) applied for both receiving DL transmission and/or transmitting UL transmission associated with the second TRP or the second TRP identifier (value),
(b) applied for (only) receiving DL transmission associated with the second TRP or the second TRP identifier (value),
(c) applied for (only) transmitting UL transmission associated with the second TRP or the second TRP identifier (value),
(d) among the second joint TCI state pool,
(e) among the second UL TCI state pool,
(f) among the second DL TCI state pool, and
(ii) at least another one of the one or more TCI state(s) may be at least one of the following (a)-(f):
(a) applied for both receiving DL transmission and/or transmitting UL transmission associated with the second TRP or the second TRP identifier (value),
(b) applied for (only) receiving DL transmission associated with the second TRP or the second TRP identifier (value),
(c) applied for (only) transmitting UL transmission associated with the second TRP or the second TRP identifier (value),
(d) among the second joint TCI state pool,
(e) among the second UL TCI state pool,
(f) among the second DL TCI state pool.

At least one TCI codepoint in a TCI field may map to one or more TCI states, where:
(i) at least one of the one or more TCI states may be at least one of the following (a)-(f):
(a) applied for both receiving DL transmission and/or transmitting UL transmission associated with the first TRP or the first TRP identifier (value),
(b) applied for (only) receiving DL transmission associated with the first TRP or the first TRP identifier (value),
(c) applied for (only) transmitting UL transmission associated with the first TRP or the first TRP identifier (value),
(d) among the first joint TCI state pool,
(e) among the first UL TCI state pool,
(f) among the first DL TCI state pool, and
(ii) at least another one of the one or more TCI states may be at least one of the following (a)-(f):
(a) applied for both receiving DL transmission and/or transmitting UL transmission associated with the second TRP or the second TRP identifier (value),
(b) applied for (only) receiving DL transmission associated with the second TRP or the second TRP identifier (value),
(c) applied for (only) transmitting UL transmission associated with the second TRP or the second TRP identifier (value),
(d) among the second joint TCI state pool,
(e) among the second UL TCI state pool,
(f) among the second DL TCI state pool.

The at least one codepoint may be (only) applied for the scheduled DL or UL transmission (e.g., scheduled by the beam indication). The at least one codepoint may not applied for channel(s) or RS(s) other than the scheduled DL or UL transmission (e.g., scheduled by the beam indication). It may indicate or imply that one or more transmission occasions are indicated or applied for the scheduled DL or UL transmission (e.g., scheduled by the beam indication).

It may indicate or imply that one or more transmission occasions are indicated or applied for the scheduled DL transmission (e.g., scheduled by the beam indication), where one or more transmission occasions may be at least one of the following (a)-(f):
(a) multiple PDSCH transmission (occasion) are scheduled (e.g., by the beam indication), which may be transmitted by or associated with the first TRP (only) or the second TRP (only): In this case, the multiple PDSCH transmission (occasions) may carry the same TB.
(b) SDM: In this case, (only) one PDSCH transmission (occasion) are scheduled (e.g., by the beam indication). The PDSCH transmission (occasion) may be transmitted by or associated with the first TRP and the second TRP. Some of layers of the PDSCH transmission (occasion) may be transmitted by or associated with the first TRP. Others of layers of the PDSCH transmission (occasion) may be transmitted by or associated with the second TRP.
(c) FDM 1: In this case, a first PDSCH transmission (occasion) and a second PDSCH transmission (occasion) are scheduled (e.g., by the beam indication). The first PDSCH transmission (occasion) and the second PDSCH transmission (occasion) may be transmitted by or associated with the first TRP and the second TRP respectively. The first PDSCH transmission (occasion) and the second PDSCH transmission (occasion) may be transmitted in FDM way. The first PDSCH transmission (occasion) and the second PDSCH transmission (occasion) may carry different partition of one or more encoded bits.
(d) FDM 2: In this case, a first PDSCH transmission (occasion) and a second PDSCH transmission (occasion) are scheduled (e.g., by the beam indication). The first PDSCH transmission (occasion) and the second PDSCH transmission (occasion) may be transmitted by or associated with the first TRP and the second TRP respectively. The first PDSCH transmission (occasion) and the second PDSCH transmission (occasion) may be transmitted in FDM way. The first PDSCH transmission (occasion) and the second PDSCH transmission (occasion) may carry different one or more encoded bits.
(e) TDM within a slot: In this case, a first PDSCH transmission (occasion) and a second PDSCH transmission (occasion) are scheduled (e.g., by the beam indication). The first PDSCH transmission (occasion) and the second PDSCH transmission (occasion) may be transmitted by or associated with the first TRP and the second TRP respectively. The first PDSCH transmission (occasion) and the second PDSCH transmission (occasion) may be transmitted in TDM way within a slot.
(f) TDM across slots: In this case, one or more PDSCH transmission (occasions) are scheduled (e.g., by the beam indication). Part of the one or more PDSCH transmission (occasions) may be transmitted by or associated with the first TRP. The other part of the one or more PDSCH transmission (occasions) may be transmitted by the second TRY. The one or more PDSCH transmission (occasions) may be transmitted in TDM way across slots.

It may indicate or imply that one or more transmission occasion is indicated or applied for the scheduled UL transmission (e.g., scheduled by the beam indication), where one or more transmission occasions may be at least one of the following (a)-(c):
(a) multiple PUSCH transmission (occasion) are scheduled (e.g., by the beam indication), which may be transmitted to or associated the first TRP (only) or the second TRP (only): In this case, the multiple PUSCH transmission (occasion) may carry the same TB.
(b) TDM within a slot: In this case, a first PUSCH transmission (occasion) and a second PUSCH transmission (occasion) are scheduled (e.g., by the beam indication). The first PUSCH transmission (occasion) and the second PUSCH transmission (occasion) may be transmitted to or associated with the first TRP and the second TRP respectively. The first PUSCH transmission (occasion) and the second PUSCH transmission (occasion) may be transmitted in TDM way within a slot.
(c) TDM across slots: In this case, one or more PUSCH transmission (occasions) are scheduled (e.g., by the beam indication). Part of the one or more PUSCH transmission (occasions) may be transmitted to or associated with the first TRP and the other part of the one or more PUSCH transmission (occasions) may be transmitted to or associated with the second TRY. The one or more PUSCH transmission (occasions) may be transmitted in TDM way across slots.

A first TCI codepoint in a TCI field may map to a first TCI state. The first TCI state may be applied for both receiving DL transmission and/or transmitting UL transmission. The first TCI state may be applied for both receiving DL transmission and/or transmitting UL transmission associated with the first TRP or the first TRP identifier (value).

A second TCI codepoint in a TCI field may map to a second TCI state. The second TCI state may be applied for (only) transmitting UL transmission. The second TCI state may be applied for (only) transmitting UL transmission associated with the first TRP or the first TRP identifier (value).

A third TCI codepoint in a TCI field may map to a third TCI state. The third TCI state may be applied for (only) receiving DL transmission. The third TCI state may be applied for (only) receiving DL transmission associated with the first TRP or the first TRP identifier (value).

A fourth TCI codepoint in a TCI field may map to a fourth TCI state. The fourth TCI state may be applied for both receiving DL transmission and/or transmitting UL transmission. The fourth TCI state may be applied for both receiving DL transmission and/or transmitting UL transmission associated with the second TRP or the second TRP identifier (value).

A fifth TCI codepoint in a TCI field may map to a fifth TCI state. The fifth TCI state may be applied for (only) transmitting UL transmission. The fifth TCI state may be applied for (only) transmitting UL transmission associated with the second TRP or the second TRP identifier (value).

A sixth TCI codepoint in a TCI field may map to a sixth TCI state. The sixth TCI state may be applied for (only) receiving DL transmission. The sixth TCI state may be applied for (only) receiving DL transmission associated with the second TRP or the second TRP identifier (value).

A seventh TCI codepoint in a TCI field may map to one or more TCI states, where:
(i) at least one of the one or more TCI states may be one of the following (a)-(f):
(a) the first TCI state,
(b) the second TCI state,
(c) the third TCI state,
(d) the fourth TCI state,
(e) the fifth TCI state,
(f) the sixth TCI state, and
(ii) at least another one of the one or more TCI states may be one of the followings (a)-(f):
(a) the first TCI state,
(b) the second TCI state,
(c) the third TCI state,
(d) the fourth TCI state,
(e) the fifth TCI state,
(f) the sixth TCI state.

The first TCI state may be a joint TCI state. The first TCI state may be activated from a joint TCI state pool. The first TCI state may be activated from a joint TCI state pool associated with the first TRP or the first TRP identifier (value).

The second TCI state may be a UL TCI state. The second TCI state may be activated from a UL TCI state pool. The second TCI state may be activated from a UL TCI state pool associated with the first TRP or the first TRP identifier (value).

The third TCI state may be a DL TCI state. The third TCI state may be activated from a DL TCI state pool. The third TCI state may be activated from a DL TCI state pool associated with the first TRP or the first TRP identifier (value).

The fourth TCI state may be a joint TCI state. The fourth TCI state may be activated from a joint TCI state pool. The fourth TCI state may be activated from a joint TCI state pool associated with the second TRP or the second TRP identifier (value).

The fifth TCI state may be a UL TCI state. The fifth TCI state may be activated from a UL TCI state pool. The fifth TCI state may be activated from a UL TCI state pool associated with the second TRP or the second TRP identifier (value).

The sixth TCI state may be a DL TCI state. The sixth TCI state may be activated from a DL TCI state pool. The sixth TCI state may be activated from a DL TCI state pool associated with the second TRP or the second TRP identifier (value).

The mapping between the first TCI codepoint and the first TCI state may be indicated by a first MAC-CE. The first TCI state may be activated by the first MAC-CE. The mapping between the second TCI codepoint and the second TCI state may be indicated by a second MAC-CE. The second TCI state may be activated by the second MAC-CE. The mapping between the third TCI codepoint and the third TCI state may be indicated by a third MAC-CE. The third TCI state may be activated by the third MAC-CE. The mapping between the fourth TCI codepoint and the fourth TCI state may be indicated by a fourth MAC-CE. The fourth TCI state may be activated by the fourth MAC-CE. The mapping between the fifth TCI codepoint and the fifth TCI state may be indicated by a fifth MAC-CE. The fifth TCI state may be activated by the fifth MAC-CE. The mapping between the sixth TCI codepoint and the sixth TCI state may be indicated by a sixth MAC-CE. The sixth TCI state may be activated by the sixth MAC-CE. The mapping between the seventh TCI codepoint and the (corresponding) one or more TCI state(s) may be indicated by a seventh MAC-CE. The (corresponding) one or more TCI state(s) may be activated by the seventh MAC-CE.

At least two among the first MAC-CE, the second MAC-CE and the third MAC-CE may be the same MAC-CE (format). The first MAC-CE, the second MAC-CE and the third MAC-CE may be the same MAC-CE (format). At least two among the fourth MAC-CE, the fifth MAC-CE and the sixth MAC-CE may be the same MAC-CE (format). The fourth MAC-CE, the fifth MAC-CE and the sixth MAC-CE may be the same MAC-CE (format). One of the first MAC-CE, the second MAC-CE or the third MAC-CE may be the same as one of the fourth MAC-CE, the fifth MAC-CE or the sixth MAC-CE. The seventh MAC-CE may be the same as one of the first MAC-CE, the second MAC-CE or the third MAC-CE, or one of the fourth MAC-CE, the fifth MAC-CE or the sixth MAC-CE.

The UE may receive or be indicated/configured with a special field. The special field may be indicated by the beam indication (e.g., a DCI, a MAC-CE, or a RRC configuration).

The special field may be used to indicate that (subsequent) DL transmission and/or UL transmission include at least one of the following features (a)-(c):
(a) all are associated with the first (value of) TRP identifier,
(b) all are associated with the second (value of) TRP identifier,
(c) some are associated with the first (value of) TRP identifier, and others are associated with the second (value of) TRP identifier.

The UE may receive one or more TCI mapping tables or mapping patterns. The UE may receive one or more TCI mapping tables or mapping patterns, and the UE may determine which one to apply based on (the indicated value of) the special field.

If or when the special field indicates that (subsequent) DL transmission and/or UL transmission are (all) associated with the first (value of) TRP identifier, the UE may (a) determine that the TCI filed (only) comprises the first TCI state, the second TCI state, or the third TCI state, and/or (b) not determine that the TCI filed comprises any of the fourth TCI state, the fifth TCI state, the sixth TCI state or the seventh TCI state.

If or when the special field indicates that (subsequent) DL transmission and/or UL transmission are (all) associated with the first (value of) TRP identifier, the network may (a) set or consider that the TCI filed (only) comprises the first TCI state, the second TCI state, or the third TCI state, and/or (b) not (be allowed to) set or consider that the TI filed comprises any of the fourth TCI state, the fifth TCI state, the sixth TCI state or the seventh TCI state.

If or when the special field indicates that (subsequent) DL transmission and/or UL transmission are (all) associated with the second (value of) TRP identifier, the UE may (a) determine that the TCI filed (only) comprises the fourth TCI state, the fifth TCI state, or the sixth TCI state, and/or (b) not determine that the TCI filed comprises any of the first TCI state, the second TCI state, the third TCI state or the seventh TCI state.

If or when the special field indicates that (subsequent) DL transmission and/or UL transmission are (all) associated with the second (value of) TRP identifier, the network may (a) set or consider that the TCI filed (only) comprises the fourth TCI state, the fifth TCI state, or the sixth TCI state, and/or (b) not (be allowed to) set or consider that the TCI filed comprises any of the first TCI state, the second TCI state, the third TCI state or the seventh TCI state.

If or when the special field indicates that some of (subsequent) DL transmission and/or UL transmission are associated with the first (value of) TRP identifier, and others of (subsequent) DL transmission and/or UL transmission are associated with the second (value of) TRP identifier, the UE may determine that the TI filed comprises at least one of the first TCI state, the second TCI state, the third TI state, the fourth TI state, the fifth TCI state, the sixth TCI state or the seventh TCI state, and/or the network may set or consider that the TCI filed comprises at least one of the first TCI state, the second TCI state, the third TCI state, the fourth TCI state, the fifth TCI state, the sixth TCI state or the seventh TCI state.

The special field may indicate a first value. The special field may indicate a second value. The special field may indicate the order or pattern of TCI state mapping.

The first value may indicate or imply at least one of the following (a)-(c):
(a) at least one of the first TCI codepoint, the second TCI codepoint or the third TCI codepoint may comprise lower TCI codepoint value than the fourth TCI codepoint, the fifth TCI codepoint or the sixth TCI codepoint,
(b) at least one of the first TCI codepoint, the second TCI codepoint or the third TCI codepoint may be prior to at least one of the fourth TCI codepoint, the fifth TCI codepoint or the sixth TCI codepoint,
(c) at least one of the first TCI state, the second TCI state and the third TCI state may be mapped to lower TCI codepoint value than at least one of the fourth TCI state, the fifth TCI state or the sixth TCI state.

The second value may indicate or imply at least one of the following (a)-(c):
(a) at least one of the fourth TCI codepoint, the fifth TCI codepoint or the sixth TCI codepoint may comprise lower TCI codepoint value than the first TCI codepoint, the second TCI codepoint or the third TCI codepoint,
(b) at least one of the fourth TCI codepoint, the fifth TCI codepoint or the sixth TCI codepoint may be prior to at least one of the first TCI codepoint, the second TCI codepoint or the third TCI codepoint,
(c) at least one of the fourth TCI state, the fifth TCI state and the sixth TCI state may be mapped to lower TI codepoint value than at least one of the first TCI state, the second TCI state or the third TCI state.

The seventh TCI codepoint may comprise the lowest TCI codepoint value. The seventh TCI codepoint may comprise the highest TCI codepoint value.

In some implementations, the beam indication may be at least one of the following (a)-(g):
(a) DCI format 1_1,
(b) DCI format 1_2,
(c) DCI format 0_1,
(d) DCI format 0_2,
(e) DCI format 1_0,
(f) DCI format 0_0,
(g) a common or group common DCI format.

The DCI format or the beam indication may include or indicate one or more TCI field or TCI state value. The DCI format or the beam indication may include or indicate a first TCI field. The DCI format or the beam indication may include or indicate a second TCI field. The DCI format or the beam indication may include or indicate a third TCI field. The DCI format or the beam indication may include or indicate a fourth TCI field. The DCI format or the beam indication may include or indicate a fifth TCI field. The DCI format or the beam indication may include or indicate a sixth TCI field. The DCI format or the beam indication may include or indicate a seventh TCI field.

One TCI field may indicate (separately) one or more TCI states applied for both receiving DL transmission and/or transmitting UL transmission. One TCI field may indicate (separately) one or more TCI states applied for both receiving DL transmission and/or transmitting UL transmission associated with the first TRP or the first TRP identifier (value). One TCI field may indicate (separately) one or more TCI states applied for both receiving DL transmission and/or transmitting UL transmission associated with the second TRP or the second TRP identifier (value).

One TCI field may indicate (separately) one or more TCI states applied for (only) transmitting UL transmission. One TCI field may indicate (separately) one or more TCI states applied for (only) transmitting UL transmission associated with the first TRP or the first TRP identifier (value). One TCI field may indicate (separately) one or more TCI states applied for (only) transmitting UL transmission associated with the second TRP or the second TRP identifier (value).

One TCI field may indicate (separately) one or more TCI states applied for (only) receiving DL transmission. One TCI field may indicate (separately) one or more TCI states applied for (only) receiving DL transmission associated with the first TRP or the first TRP identifier (value). One TCI field may indicate (separately) one or more TCI states applied for (only) receiving DL transmission associated with the second TRP or the second TRP identifier (value).

At least one TCI field may indicate one or more TCI states, where the one or more TCI states may be (a) applied for both receiving DL transmission and/or transmitting UL transmission associated with the first TRP or the first TRP identifier (value), and/or (b) applied for (only) receiving DL transmission associated with the first TRP or the first TRP identifier (value), and/or (c) applied for (only) transmitting UL transmission associated with the first TRP or the first TRP identifier (value).

At least one TCI field may indicate one or more TCI states, where the one or more TCI states may be (a) applied for both receiving DL transmission and/or transmitting UL transmission associated with the second TRP or the second TRP identifier (value), and/or (b) applied for (only) receiving DL transmission associated with the second TRP or the second TRP identifier (value), and/or (c) applied for (only) transmitting UL transmission associated with the second TRP or the second TRP identifier (value).

At least one TCI codepoint in a TCI field may indicate one or more TCI states, where:
(i) at least some of the one or more TCI state(s) may be at least one of the following (a)-(c):
(a) applied for both receiving DL transmission and/or transmitting UL transmission associated with the first TRP or the first TRP identifier (value),
(b) applied for (only) receiving DL transmission associated with the first TRP or the first TRP identifier (value),
(c) applied for (only) transmitting UL transmission associated with the first TRP or the first TRP identifier (value), and
(ii) at least others of the one or more TCI state(s) may be at least one of the following (a)-(c):
(a) applied for both receiving DL transmission and/or transmitting UL transmission associated with the second TRP or the second TRP identifier (value),
(b) applied for (only) receiving DL transmission associated with the second TRP or the second TRP identifier (value),
(c) applied for (only) transmitting UL transmission associated with the second TRP or the second TRP identifier (value).

The first TCI field may indicate a first TCI state. The first TCI state may be applied for both receiving DL transmission and/or transmitting UL transmission. The first TCI state may be applied for both receiving DL transmission and/or transmitting UL transmission associated with the first TRP or the first TRP identifier (value).

The second TCI field may indicate a second TCL state. The second TCI state may be applied for (only) transmitting UL transmission. The second TCI state may be applied for (only) transmitting UL transmission associated with the first TRP or the first TRP identifier (value).

The third TCI field may indicate a third TCI state. The third TCI state may be applied for (only) receiving DL transmission. The third TCI state may be applied for (only) receiving DL transmission associated with the first TRP or the first TRP identifier (value).

The fourth TCI field may indicate a fourth TCI state. The fourth TCI state may be applied for both receiving DL transmission and/or transmitting UL transmission. The fourth TCI state may be applied for both receiving DL transmission and/or transmitting UL transmission associated with the second TRP or the second TRP identifier (value).

The fifth TCI field may indicate a fifth TCI state. The fifth TCI state may be applied for (only) transmitting UL transmission. The fifth TCI state may be applied for (only) transmitting UL transmission associated with the second TRP or the second TRP identifier (value).

The sixth TCI field may indicate a sixth TCI state. The sixth TCI state may be applied for (only) receiving DL transmission. The sixth TCI state may be applied for (only) receiving DL transmission associated with the second TRP or the second TRP identifier (value).

The seventh TCI field may indicate one or more TCI states, where:
(i) at least one of the one or more TI states may be one of the following (a)-(f):
(a) the first TCI state,
(b) the second TCI state,
(c) the third TCI state,
(d) the fourth TCI state,
(e) the fifth TCI state,
(f) the sixth TCI state, and
(ii) at least another one of the one or more TCI states may be one of the following (a)-(f):
(a) the first TCI state,
(b) the second TCI state,
(c) the third TCI state,
(d) the fourth TCI state,
(e) the fifth TCI state,
(f) the sixth TCI state.

The first TCI state may be a joint TCI state. The first TCI state may be activated from a joint TCI state pool. The first TCI state may be activated from a joint TCI state pool associated with the first TRP or the first TRP identifier (value).

The second TCI state may be a UL TCI state. The second TCI state may be activated from a UL TCI state pool. The second TCI state may be activated from a UL TCI state pool associated with the first TRP or the first TRP identifier (value).

The third TCI state may be a DL TCI state. The third TCI state may be activated from a DL TCI state pool. The third TCI state may be activated from a DL TCI state pool associated with the first TRP or the first TRP identifier (value).

The fourth TCI state may be a joint TCI state. The fourth TCI state may be activated from a joint TCI state pool. The fourth TCI state may be activated from a joint TCI state pool associated with the second TRP or the second TRP identifier (value).

The fifth TCI state may be a UL TCI state. The fifth TCI state may be activated from a UL TCI state pool. The fifth TCI state may be activated from a UL TCI state pool associated with the second TRP or the second TRP identifier (value).

The sixth TCI state may be a DL TCI state. The sixth TCI state may be activated from a DL TCI state pool. The sixth TCI state may be activated from a DL TCI state pool associated with the second TRP or the second TRP identifier (value).

The mapping between the first TCI state and one of codepoint in the first TCI field may be indicated by a first MAC-CE. The first TCI state may be activated by the first MAC-CE. The mapping between the second TCI state and one of codepoint in the second TCI field may be indicated by a second MAC-CE. The second TCI state may be activated by the second MAC-CE. The mapping between the third TCI state and one of codepoint in the third TCI field may be indicated by a third MAC-CE. The third TCI state may be activated by the third MAC-CE. The mapping between the fourth TCI state and one of codepoint in the fourth TCI field may be indicated by a fourth MAC-CE. The fourth TCI state may be activated by the fourth MAC-CE. The mapping between the fifth TCI state and one of codepoint in the fifth TCI field may be indicated by a fifth MAC-CE. The fifth TCI state may be activated by the fifth MAC-CE. The mapping between the sixth TCI state and one of codepoint in the sixth TCI field may be indicated by a sixth MAC-CE. The sixth TCI state may be activated by the sixth MAC-CE. The mapping between the (corresponding) one or more TCI states and one of codepoint in the seventh TCI field may be indicated by a seventh MAC-CE. The (corresponding) one or more TCI state(s) may be activated by the seventh MAC-CE.

At least two among the first MAC-CE, the second MAC-CE and the third MAC-CE may be the same MAC-CE (format). The first MAC-CE, the second MAC-CE and the third MAC-CE may be the same MAC-CE (format). At least two among the fourth MAC-CE, the fifth MAC-CE and the sixth MAC-CE may be the same MAC-CE (format). The fourth MAC-CE, the fifth MAC-CE and the sixth MAC-CE may be the same MAC-CE (format). One of the first MAC-CE, the second MAC-CE or the third MAC-CE may be the same as one of the fourth MAC-CE, the fifth MAC-CE or the sixth MAC-CE. The seventh MAC-CE may be the same as one of the first MAC-CE, the second MAC-CE or the third MAC-CE, or one of the fourth MAC-CE, the fifth MAC-CE or the sixth MAC-CE.

If a same TCI state or source RS is applied for both receiving DL transmission and/or transmitting UL transmission, and/or if the UE is indicated to operate in joint TCI state type/mode, the indicated TCI state in the second TCI field and that in the third TCI field are the same, and/or the indicated TCI state in the fifth TCI field and that in the sixth TCI field are the same, and/or the second TCI state and third TCI state are the same, and/or the fifth TCI state and the sixth TCI state are the same.

If a same TCI state or source RS is applied for both receiving DL transmission and/or transmitting UL transmission associated with the first TRP or the first TRP identifier (value), and/or if the UE is indicated to operate in joint TCI state mode at least for receiving DL transmission and/or transmitting UL transmission associated with the first TRP or the first TRP identifier (value), the indicated TCI state in the second TCI field and that in the third TCI field are the same, and/or the second TCI state and third TCI state are the same.

If a same TCI state or source RS is applied for both receiving DL transmission and/or transmitting UL transmission associated with the second TRP or the second TRP identifier (value), and/or if the UE is indicated to operate in joint TI state mode at least for receiving DL transmission and/or transmitting UL transmission associated with the second TRP or the second TRP identifier (value), the indicated TCI state in the fifth TCI field and that in the sixth TCI field are the same, and/or the fifth TI state and the sixth TCI state are the same.

The UE may receive or be indicated/configured with a special field. The special field may be indicated by the beam indication (e.g., DCI, a MAC-CE, or a RRC configuration). The special field may be used to indicate that (subsequent) DL transmission and/or UL transmission includes at least one of the following features (a)-(c):
(a) all are associated with the first (value of) TRP identifier,
(b) all are associated with the second (value of) TRP identifier,
(c) some are associated with the first (value of) TRP identifier, and others are associated with the second (value of) TRP identifier.

The UE may receive one or more TCI mapping tables or mapping patterns. The UE may receive one or more TCI mapping tables or mapping patterns, and the UE may determine which one to apply based on (the indicated value of) the special field.

If or when the special field indicates that (subsequent) DL transmission and/or UL transmission are (all) associated with the first (value of) TRP identifier, the UE may (a) determine that (only) at least one of the first TCI field, the second TCI field or the third TCI field are present or valid, and/or (b) not determine that one of the fourth TCI field, the fifth TCI field, the sixth field or the seventh TCI field are present or valid, and/or (c) determine that at least one of the fourth TCI field, the fifth TCI field, the sixth field or the seventh TCI field can be ignored or be not used.

If or when the special field indicates that (subsequent) DL transmission and/or UL transmission are (all) associated with the second (value of) TRP identifier, the UE may (a) determine that (only) at least one of the fourth TCI field, the fifth TCI field or the sixth TCI field are present or valid, and/or (b) not determine that one of the first TCI field, the second TCI field, the third field or the seventh TCI field are present or valid, and/or (c) determine that at least one of the first TCI field, the second TCI field, the third field or the seventh TCI field can be ignored or be not used.

If or when the special field indicates that some of (subsequent) DL transmission and/or UL transmission are associated with the first (value of) TRP identifier, and others of (subsequent) DL transmission and/or UL transmission are associated with the second (value of) TRP identifier, the UE may determine that at least one of the first TCI field, the second TCI field, the third field, the fourth TCI field, the fifth TCI field, the sixth TCI field or the seventh TCI field are present or valid.

The special field may indicate a first value. The special field may indicate a second value. The special field may indicate the order or pattern of TCI field interpretation or positioning in the beam indication or a DCI.

The first value may indicate or imply that at least one of the first TCI field, the second TCI field or the third TCI field is prior to at least one of the fourth TCI field, the fifth TI field or the sixth TCI field (e.g., comprising more significant bits in the beam indication or the DCI). The second value may indicate or imply that at least one of the fourth TCI field, the fifth TCI field or the sixth TCI field is prior to at least one of the first TCI field, the second TCI field or the third TCI field (e.g., comprising more significant bits in the beam indication or the DCI).

The seventh TCI field may comprise more significant bits than other TCI field (if any) in the beam indication or the DCI. The seventh TCI field may comprise less significant bits than other TCI field (if any) in the beam indication or the DCI.

In some implementations, the UE may monitor and/or receive a first beam indication. The UE may monitor and/or receive a second beam indication.

The first beam indication may be applied for at least one of the following (a)-(c):
(a) both receiving DL transmission and/or transmitting UL transmission: In this case, the first beam indication may comprise or indicate a first set of RX parameters for receiving one or more DL transmissions (e.g., channel, RS). The first beam indication may comprise or indicate a first set of TX parameters for transmitting one or more UL transmissions (e.g., channel, RS).
(b) (only) transmitting UL transmission: In this case, the first beam indication may comprise or indicate a first set of TX parameters for transmitting one or more UL transmissions (e.g., channel, RS).
(c) (only) receiving DL transmission: In this case, the first beam indication may comprise or indicate a first set of RX parameters for receiving one or more DL transmissions (e.g., channel, RS).

The second beam indication may be applied for at least one of the following (a)-(c):
(a) both receiving DL transmission and/or transmitting UL transmission:

In this case, the second beam indication may comprise or indicate a second set of RX parameters for receiving one or more DL transmissions (e.g., channel, RS). The second beam indication may comprise or indicate a second set of TX parameters for transmitting one or more UL transmissions (e.g., channel, RS).
(b) (only) transmitting UL transmission: In this case, the second beam indication may comprise or indicate a second set of TX parameters for transmitting one or more UL transmissions (e.g., channel, RS).
(c) (only) receiving DL transmission: In this case, the second beam indication may comprise or indicate a second set of RX parameters for receiving one or more DL transmissions (e.g., channel, RS).

When (or if) the UE receives the first beam indication, the UE may (a) apply the first set of RX parameters for receiving one or more configured/indicated DL transmission (e.g., channel, RS) if the first beam indication comprises or indicates the first set of RX parameters, and/or (b) apply the first set of TX parameters for transmitting one or more configured/indicated UL transmission (e.g., channel, RS) if the first beam indication comprises or indicates the first set of TX parameters.

The UE may receive the second beam indication. After the UE receives the first beam indication, the UE may receive the second beam indication.

When (or if) the UE receives the second beam indication, the UE may (a) apply the second set of RX parameters for receiving one or more configured/indicated DL transmission (e.g., channel, RS), if the second beam indication comprises or indicates the second set of RX parameters, and/or (b) apply the second set of TX parameters for transmitting one or more configured/indicated UL transmission (e.g., channel, RS), if the second beam indication comprises or indicates the second set of TX parameters, and/or (c) discard or not use the first set of RX parameters for receiving the one or more configured/indicated DL transmission (e.g., channel, RS), if the first beam indication comprises or indicates the first set of RX parameters, and/or (d) discard or not use the first set of TX parameters for transmitting the one or more configured/indicated UL transmission (e.g., channel, RS), if the first beam indication comprises or indicates the first set of TX parameters.

In some implementations, the UE may receive a first beam indication. The UE may receive a second beam indication.

The beam indication, the first beam indication or the second beam indication may be at least one of the following (a)-(g):
(a) DCI format 1_1,
(b) DCI format 1_2,
(c) DCI format 0_1,
(d) DCI format 0_2,
(e) DCI format 1_0,
(f) DCI format 0_0,
(g) a common or group common DCI format.

The first beam indication may be a DCI format with DL data scheduling. The first beam indication may be DCI format 1_1 and/or DCI format 1_2. The first beam indication may be DCI format 1_1 and/or DCI format 1_2, which schedules valid or actual DL data assignment.

The second beam indication may be a DCI format without DL data scheduling. The second beam indication may be DCI format 1_1 and/or DCI format 1_2. One or more DCI fields of the second beam indication may be modified or reused from (that of) DCI format 1_1 and/or DCI format 1_2. One or more DCI fields of the second beam indication may be modified or reused from (that of) DCI format 1_1 and/or DCI format 1_2 for DL data scheduling. The second beam indication may be DCI format 1_1 and/or DCI format 1_2, which does not schedule valid or actual DL data assignment. The DCI format without DL data scheduling may be derived from a DCI format with DL data scheduling, where some DCI fields related to data scheduling in the DCI format may be ignored or repurposed.

The second beam indication may carry or include a specific field. The specific field may comprise one or more bits. The specific field may indicate whether the UE is to operate a joint TCI state type/mode or a separate TCI state type/mode. The specific field may (only) be present in the second beam indication if configured by higher layers. The first beam indication and the second beam indication may be received in same or different slot or timing unit.

The first beam indication may be (only) used for TCI state or source RS applied (a) for both receiving DL transmission and/or transmitting UL transmission associated with the first TRP or the first TRP identifier (value), and/or (b) for (only) receiving DL transmission associated with the first TRP or the first TRP identifier (value), and/or (c) for (only) transmitting UL transmission associated with the first TRP or the first TRP identifier (value).

The first beam indication may be not (allowed to be) used for TCI state or source RS applied (a) for both receiving DL transmission and/or transmitting UL transmission associated with the second TRP or the second TRP identifier (value), and/or (b) for (only) receiving DL transmission associated with the second TRP or the second TRP identifier (value), and/or (c) for (only) transmitting UL transmission associated with the second TRP or the second TRP identifier (value).

The second beam indication may be (only) used for TCI state or source RS applied (a) for both receiving DL transmission and/or transmitting UL transmission associated with the first TRP or the first TRP identifier (value), and/or (b) for (only) receiving DL transmission associated with the first TRP or the first TRP identifier (value), and/or (c) for (only) transmitting UL transmission associated with the first TRP or the first TRP identifier (value), and/or (d) for both receiving DL transmission and/or transmitting UL transmission associated with the second TRP or the second TRP identifier (value), and/or (e) for (only) receiving DL transmission associated with the second TRP or the second TRP identifier (value), and/or (f) for (only) transmitting UL transmission associated with the second TRP or the second TRP identifier (value).

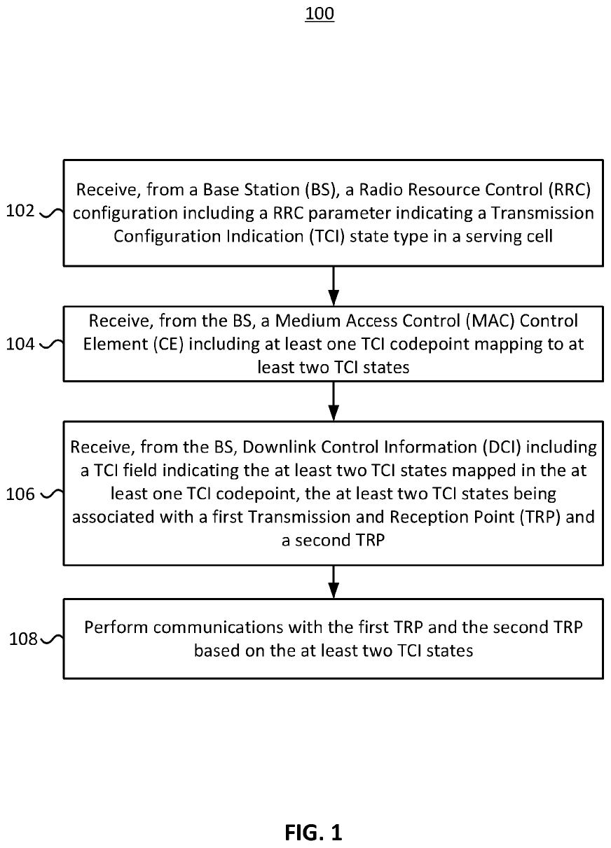

FIG. 1 is a flowchart illustrating a method 100 for a UE for beam indication in Multi-Transmission and Reception Point (MTRP) according to an example implementation of the present disclosure. Although actions 102, 104, 106, and 108 are illustrated as separate actions represented as independent blocks in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternate method. Moreover, each of actions 102, 104, 106, and 108 may be performed independently of other actions and can be omitted in some implementations of the present disclosure.

In action 102, the UE may receive, from a Base Station (BS), a Radio Resource Control (RRC) configuration including a RRC parameter indicating a Transmission Configuration Indication (TCI) state type in a serving cell. The TCI state type may be a joint TCI state type or a separate TCI state type.

In action 104, the UE may receive, from the BS, a Medium Access Control (MAC) Control Element (CE) including at least one TCI codepoint mapping to at least two TCI states.

In action 106, the UE may receive, from the BS, Downlink Control Information (DCI) including a TCI field indicating the at least two TCI states mapped in the at least one TCI codepoint. The at least two TCI states may be associated with a first Transmission and Reception Point (TRP) and a second TRP.

In some implementations, the first TRP may be associated with a first TRP identifier (ID), and the second TRP may be associated with a second TRP ID. In some implementations, the first TRP may be associated with a first Control Resource Set (CORESET) pool index, and the second TRP may be associated with a second CORESET pool index.

In action 108, the UE may perform communications with the first TRP and the second TRP based on the at least two TCI states.

In some implementations, the RRC parameter may indicate a joint TCI state type, the at least two TCI states may include a first joint TCI state and a second joint TCI state, the first joint TCI state may correspond to the first TRP, and the second joint TCI state may correspond to the second TRP. The UE may perform first DL reception and first UL transmission with the first TRP based on the first joint TCI state, and perform second DL reception and second UL transmission with the second TRP based on the second joint TCI state. In some implementations, the RRC configuration may further indicate one or more TCI state lists, and the first joint TCI state and the second joint TCI state may be obtained from a joint TCI state list of the one or more TCI state lists.

In some implementations, the RRC parameter may indicate a separate TCI state type, the at least two TCI states may include a first DL TCI state, a first UL TCI state, a second DL TCI state and a second UL TCI state, the first DL TCI state and the first UL TCI state may correspond to the first TRP, and the second DL TCI state and the second UL TCI state may correspond to the second TRP. The UE may perform first DL reception with the first TRP based on the first DL TCI state, perform first UL transmission with the first TRP based on the first UL TCI state, perform second DL reception with the second TRP based on the second DL TCI state, and perform second UL transmission with the second TRP based on the second UL TCI state. In some implementations, the RRC configuration may further indicate one or more TCI state lists, the first DL TCI state and the second DL TCI state may be obtained from a DL TCI state list of the one or more TCI state lists, and the first UL TCI state and the second UL TCI state may be obtained from a UL TCI state list of the one or more TCI state lists.

In the present disclosure, a beam indication scheme is provided for supporting Multi-Transmission and Reception Point (MTRP) operations. Based on such a beam indication scheme, the MTRP operations can work more efficiently to achieve high reliability and high-throughput communications.

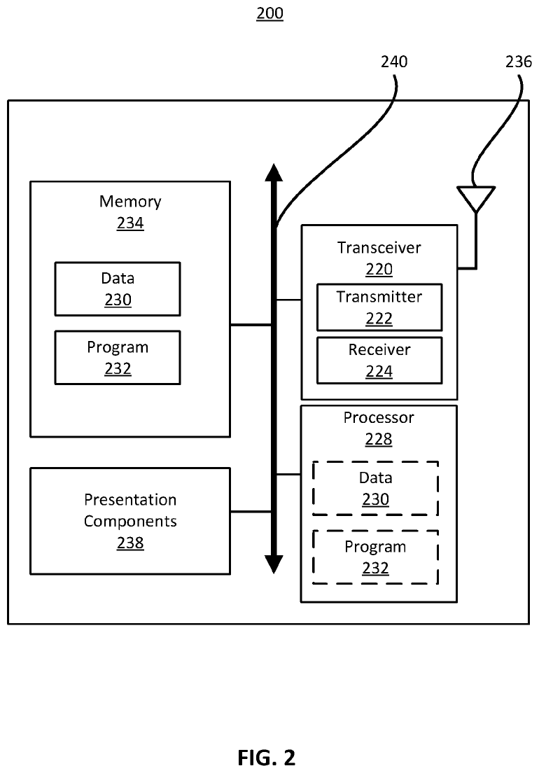

FIG. 2 is a block diagram illustrating a node 200 for wireless communication according to an example implementation of the present disclosure. As illustrated in FIG. 2, a node 200 may include a transceiver 220, a processor 228, a memory 234, one or more presentation components 238, and at least one antenna 236. The node 200 may also include a radio frequency (RF) spectrum band module, a BS communications module, a network communications module, and a system communications management module, Input/Output (I/O) ports, I/O components, and a power supply (not illustrated in FIG. 2).

Each of the components may directly or indirectly communicate with each other over one or more buses 240. The node 200 may be a UE or a BS that performs various functions disclosed with reference to FIG. 1.

The transceiver 220 has a transmitter 222 (e.g., transmitting/transmission circuitry) and a receiver 224 (e.g., receiving/reception circuitry) and may be configured to transmit and/or receive time and/or frequency resource partitioning information. The transceiver 220 may be configured to transmit in different types of subframes and slots including but not limited to usable, non-usable, and flexibly usable subframes and slot formats. The transceiver 220 may be configured to receive data and control channels.

The node 200 may include a variety of computer-readable media. Computer-readable media may be any available media that may be accessed by the node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules or other data in a modulated data signal such as a carrier wave or other transport mechanisms and include any information delivery media.

The term “modulated data signal” may mean a signal that has one or more of its characteristics set or changed in such a manner as to encode information in the signal. Communication media may include wired media such as a wired network or direct-wired connection, and wireless media such as acoustic, RF, infrared, and other wireless media. Combinations of any of the previously listed components should also be included within the scope of computer-readable media.

The memory 234 may include computer-storage media in the form of volatile and/or non-volatile memory. The memory 234 may be removable, non-removable, or a combination thereof. Example memory may include solid-state memory, hard drives, optical-disc drives, etc. As illustrated in FIG. 2, the memory 234 may store a computer-readable and/or computer-executable program 232 (e.g., software codes) that are configured to, when executed, cause the processor 228 to perform various functions disclosed herein, for example, with reference to FIG. 1. Alternatively, the program 232 may not be directly executable by the processor 228 but may be configured to cause the node 200 (e.g., when compiled and executed) to perform various functions disclosed herein.

The processor 228 (e.g., having processing circuitry) may include an intelligent hardware device (e.g., a Central Processing Unit (CPU), a microcontroller, an ASIC, etc). The processor 228 may include memory. The processor 228 may process the data 230 and the program 232 received from the memory 234, and information transmitted and received via the transceiver 220, the base band communications module, and/or the network communications module. The processor 228 may also process information to send to the transceiver 220 for transmission via the antenna 236 to the network communications module for transmission to a CN.

One or more presentation components 238 may present data indications to a person or another device. Examples of presentation components 238 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1-14. (canceled)

15. A method performed by a user equipment (UE) for beam indication in a multi-transmission and reception point (MTRP), the method comprising:
receiving, from a base station (BS), first downlink control information (DCI) including a first transmission configuration indication (TCI) field indicating a first TCI state, the first DCI being associated with a first value;
receiving, from the BS, second DCI including a second TCI field indicating a second TCI state, the second DCI being associated with a second value;
performing, based on the first TCI state, a first uplink (UL) transmission; and
performing, based on the second TCI state, a second UL transmission, wherein:
the first UL transmission is scheduled by third DCI associated with the first value, and
the second UL transmission is scheduled by fourth DCI associated with the second value.

16. The method of claim 15, further comprising:
receiving, from the BS, a radio resource control (RRC) configuration including an RRC parameter indicating a TCI state type in a serving cell, wherein:
the RRC parameter indicates a joint TCI state type, and
the first TCI state and the second TCI state are configured in a joint TCI state list.

17. The method of claim 15, further comprising:
receiving, from the BS, a radio resource control (RRC) configuration including an RRC parameter indicating a TCI state type in a serving cell, wherein:
the RRC parameter indicates a separate TCI state type, and
the first TCI state and the second TCI state are configured in a UL TCI state list.

18. The method of claim 15, wherein the first DCI and the second DCI are downlink (DL) DCI.

19. The method of claim 15, wherein the third DCI and the fourth DCI are UL DCI.

20. A user equipment (UE) for beam indication in a multi-transmission and reception point (MTRP), the UE comprising:
one or more processors; and
at least one memory coupled to the one or more processors, the at least one memory storing one or more computer-executable instructions that, when executed by the one or more processors, cause the UE to:
receive, from a base station (BS), first downlink control information (DCI) including a first transmission configuration indication (TCI) field indicating a first TCI state, the first DCI being associated with a first value;
receive, from the BS, second DCI including a second TCI field indicating a second TCI state, the second DCI being associated with a second value;
perform, based on the first TCI state, a first uplink (UL) transmission; and
perform, based on the second TCI state, a second UL transmission, wherein:
the first UL transmission is scheduled by third DCI associated with the first value, and
the second UL transmission is scheduled by fourth DCI associated with the second value.

21. The UE of claim 20, wherein the one or more computer-executable instructions, when executed by the one or more processors, further cause the UE to:
receive, from the BS, a radio resource control (RRC) configuration including an RRC parameter indicating a TCI state type in a serving cell, wherein:
the RRC parameter indicates a joint TCI state type, and
the first TCI state and the second TCI state are configured in a joint TCI state list.

22. The UE of claim 20, wherein the one or more computer-executable instructions, when executed by the one or more processors, further cause the UE to:
receive, from the BS, a radio resource control (RRC) configuration including an RRC parameter indicating a TCI state type in a serving cell, wherein:
the RRC parameter indicates a separate TCI state type, and
the first TCI state and the second TCI state are configured in a UL TCI state list.

23. The UE of claim 20, wherein the first DCI and the second DCI are downlink (DL) DCI.

24. The UE of claim 20, wherein the third DCI and the fourth DCI are UL DCI.

25. A base station (BS) for beam indication in a multi-transmission and reception point (MTRP), the BS comprising:
one or more processors; and
at least one memory coupled to the one or more processors, the at least one memory storing one or more computer-executable instructions that, when executed by the one or more processors, cause the BS to:
transmit, to a user equipment (UE), first downlink control information (DCI) including a first transmission configuration indication (TCI) field indicating a first TCI state, the first DCI being associated with a first value;
transmit, to the UE, second DCI including a second TCI field indicating a second TCI state, the second DCI being associated with a second value;
perform, based on the first TCI state, a first uplink (UL) reception; and
perform, based on the second TCI state, a second UL reception, wherein:
the first UL reception is scheduled by third DCI associated with the first value, and
the second UL reception is scheduled by fourth DCI associated with the second value.

26. The BS of claim 25, wherein the one or more computer-executable instructions, when executed by the one or more processors, further cause the BS to:
transmit, to the UE, a radio resource control (RRC) configuration including an RRC parameter indicating a TCI state type in a serving cell, wherein:
the RRC parameter indicates a joint TCI state type, and
the first TCI state and the second TCI state are configured in a joint TCI state list.

27. The BS of claim 25, wherein the one or more computer-executable instructions, when executed by the one or more processors, further cause the BS to:
transmit, to the UE, a radio resource control (RRC) configuration including an RRC parameter indicating a TCI state type in a serving cell, wherein:
the RRC parameter indicates a separate TCI state type, and
the first TCI state and the second TCI state are configured in a UL TCI state list.

28. The BS of claim 25, wherein the first DCI and the second DCI are downlink (DL) DCI.

29. The BS of claim 25, wherein the third DCI and the fourth DCI are UL DCI.
